(19) United States
(12) Patent Application Publication
(10) Pub. No.: US 2013/0301127 A1
(43) Pub. Date: Nov. 14, 2013

(54) WAVE PLATE AND METHOD FOR PRODUCING WAVE PLATE

(71) Applicant: Asahi Glass Company, Limited, Tokyo (JP)

(72) Inventors: Gousuke Yoshida, Tokyo (JP); Motoshi Ono, Tokyo (JP); Mitsuru Watanabe, Tokyo (JP)

(73) Assignee: Asahi Glass Company, Limited, Tokyo (JP)

(21) Appl. No.: 13/946,670

(22) Filed: Jul. 19, 2013

Related U.S. Application Data
(63) Continuation of application No. PCT/JP2012/050758, filed on Jan. 16, 2012.

(30) Foreign Application Priority Data
Jan. 20, 2011 (JP) 2011-010240
Jul. 19, 2011 (JP) 2011-158406

(51) Int. Cl. G02B 5/30; C03C 23/00

(52) U.S. Cl. CPC G02B 5/3083; C03C 23/0025
USPC 359/486.01; 65/111; 65/29.18

(57) ABSTRACT

To provide a low-cost wave plate that does not cause any diffracted light and wavefront aberrations. The challenge is met by providing a wave plate characterized by including a first region, a second region, and a third region which are placed on a glass substrate. The first region and the second region exhibit each uniaxial birefringence at least in their portions. The third region exhibits uniaxial birefringence and is interposed between the first region and the second region. Phase advance axes of birefringence of the first region and the second region are substantially parallel to each other. A phase advance axis of birefringence of the third region is substantially orthogonal to the phase advance axes of birefringence of the first and second regions.

### TECHNICAL FIELD

The invention relates to a wave plate and a method for producing a wave plate.

### BACKGROUND ART

A wave plate, like a quarter-wave plate and a half-wave plate, has been used for controlling an optical phase and polarization. The wave plate is an optical element that outputs linearly polarized light parallel to a certain axis and linearly polarized light perpendicular to the axis which differ from each other in terms of a propagation rate. Crystal, mica, liquid crystal, and the like, that are birefringent materials have generally been used as such a wave plate. The quarter-wave plate, the half-wave plate, and the like, are produced by processing the birefringent material to a predetermined thickness.

However, the wave plate that is produced as mentioned above incurs an increase in material cost and production cost, and hence the thus-produced wave plate also becomes expensive. For these reasons, Patent Documents 1 and 2 disclose a method for imparting birefringence to glass by use of a laser and a technique pertinent to a wave plate that is fabricated by exposing glass to a laser. The techniques are conceived by paying attention to the fact that, as a result of glass being exposed to a laser beam, a change occurs in retardation of an exposed region of the glass. Wave plates are fabricated on the basis of the fact.

### PRIOR ART REFERENCE

### Patent Document

Patent Document 1: JP-A-2007-238342
Patent Document 2: International Publication No. WO 2008/126828

### SUMMARY OF THE INVENTION

### Problems to be Solved by the Invention

Incidentally, in the wave plates fabricated under the producing methods described in connection with Patent Documents 1 and 2, a region on a glass substrate exposed to a laser beam acts as a wave plate. A wave plate is fabricated by irradiating a predetermined region, in a scanning manner, with a laser beam having a narrow beam spot. In this case, the laser beam to be applied to the predetermined region scans at a predetermined pitch. Hence, a difference arises between an area directly exposed to the laser beam and the other area in terms of a magnitude of induced stresses. This sometimes causes problems, such as unevenness in optical property, occurrence of diffracted light or a wavefront aberration.

In addition, the laser beam has a beam spot in a predetermined shape. An even light intensity distribution does not exist in the beam spot. A center portion of the beam spot exhibits higher light intensity, whilst a peripheral portion of the beam spot exhibits lower light intensity. Therefore, even in the beam spot, the center portion is subjected to a higher temperature than is the peripheral portion. For this reason, even if the pitch between the scanning laser beams is made short, the problems might not be solved.

Further, a conceivable method for solving the problems is to provide a laser beam irradiation apparatus for irradiating a laser beam with another optical member, or the like, that makes a correction on the light intensity distribution. However, in this case, the laser beam irradiation apparatus is expensive, which will in turn add to the cost of production of a wave plate to be fabricated.

The invention has been conceived in light of the circumstance and aims at providing a low-cost wave plate that does not induce diffracted light or a wavefront aberration and a method for producing the wave plate.

### Solution to the Problems

The invention is characterized by a wave plate that comprises a first region, a second region, and a third region which are placed on a glass substrate, wherein

the first region and the second region exhibit each uniaxial birefringence at least in their portions;

the third region exhibits uniaxial birefringence and interposed between the first region and the second region;

phase advance axes of birefringence of the first region and the second region are substantially parallel to each other; and

a phase advance axis of birefringence of the third region is substantially orthogonal to the phase advance axes of birefringence of the first and second regions.

In the invention, the first region and the second region are created by irradiation of a laser beam, and the third region is a region that is not exposed to the laser beam.

Moreover, in the invention, a scan direction of a laser beam that is radiated on the first region in a scanning manner and a scan direction of a laser beam that is radiated on the second region in a scanning manner are substantially parallel to each other.

Furthermore, in the invention, a refractive index achieved in the third region along a direction parallel to the scan direction of the laser beam is higher than a refractive index achieved in a direction perpendicular to the scan direction of the laser beam.

Also, the invention, the first region and the second region are placed substantially parallel to each other.

In addition, in the invention, a spacing between the first region and the second region is wider than a diameter of a beam spot that enters the wave plate.

Moreover, in the invention, retardation of the third region corresponds to a quarter or a half of a wavelength of the light that enters the wave plate.

The invention is also characterized by a method for producing a wave plate that includes a first region, a second region, and a third region which are placed on a glass substrate, and the third region is interposed between the first region and the second region, the method comprising a step of fabricating the first region on the glass substrate by performing a scan with irradiation of a laser beam in one direction, and a step of fabricating the second region that is spaced apart from the first region by a predetermined distance, by performing a scan with irradiation of the laser beam substantially in parallel to the one direction.

Further, in the invention, irradiation of the laser beam is performed a plurality of times substantially parallel to the one direction with respect to a thicknesswise or planar direction of the glass substrate.

Moreover, in the invention, processing pertaining to the step of fabricating the first region and processing pertaining to the step of fabricating the second region are simultaneously performed.

A method for producing on a glass substrate a wave plate with a birefringent region, comprising:

(a) preparing a glass substrate; and

(b) irradiating a first region on the glass substrate and a second region spaced apart from the first region with a laser beam in a stationary manner, whereby

a first peak of retardation value appears in the first region and a second peak of the retardation value appears in the second region with respect to a direction that traverses the first and second regions, and a flat part or peak of the retardation value is formed in a third region between the first and second regions.

The first region is fabricated by irradiation of one or a plurality of first laser beams; and the second region is fabricated by irradiation of one or a plurality of second laser beams.

At least one first laser beam and/or at least one second laser beam have a linear or elliptical laser spot.

The first, third, and second regions are fabricated along a first direction; laser spots of the plurality of first laser beams to be radiated on the first region are arrayed along a second direction substantially perpendicular to the first direction; and laser spots of the plurality of second laser beams to be radiated on the second region are arrayed along the second direction.

The first, third, and second regions are fabricated along the first direction; at least one linear or elliptical laser spot of the first laser beam is arrayed such that a major axis of the laser spot becomes parallel to the second direction that is substantially perpendicular to the first direction, and/or at least one linear or elliptical laser spot of the second laser beam is arrayed such that a major axis of the laser spot becomes parallel to the second direction that is substantially perpendicular to the first direction.

The laser spots of the plurality of first laser beams make up a plurality of lines along the second direction, and the laser spots of the plurality of second laser beams make up a plurality of lines along the second direction.

Moreover, the laser spots of the plurality of first laser beams are each a linear or elliptical laser spot; the laser spots of the plurality of second laser beams are each a linear or elliptical laser spot; the linear or elliptical laser spots of the first laser beams are arrayed such that a major axis of each of the laser spots is arrayed in parallel to the second direction; the linear or elliptical laser spots of the second laser beams are arrayed such that a major axis of each of the laser spots is arrayed in parallel to the second direction.

Also, the laser spots of the plurality of first laser beams have intensity such that both ends of the line of laser spots have higher intensity; and the laser spots of the plurality of second laser beams have intensity such that both ends of the line of laser spots have higher intensity.

In connection with (b), the laser beam is irradiated on the first region and the second region simultaneously.

In connection with (b), the laser beam is irradiated on the second region after being radiated on the first region.

A spacing between the first region and the second region is a maximum of 10 mm or less.

The step (b) includes a step of irradiating, at a first depth of the glass substrate, the first region of the glass substrate and the second region spaced apart from the first region with the laser beam in a stationary manner; and a step of irradiating, at a second depth of the glass substrate, a fourth region of the glass substrate and a fifth region spaced apart from the fourth region with the laser beam in a stationary manner, wherein the fourth region coincides with the first region when viewed in a thicknesswise direction of the glass substrate, and the fifth region coincides with the second region when viewed in the thicknesswise direction of the glass substrate.

### Advantageous Effects of the Invention

The invention can provide a low-cost wave plate that does not induce diffracted light or a wavefront aberration and a method for producing the wave plate.

### BRIEF DESCRIPTION OF THE DRAWINGS

FIG. 1A is a structural drawing of a wave plate of an implementation configuration.

FIG. 1B is a structural drawing of the wave plate of the implementation configuration.

FIG. 2 is a structural drawing of an apparatus for producing the wave plate of the implementation configuration.

FIG. 3 is a flowchart of a method for producing a wave plate of the implementation configuration.

FIG. 4A is a process drawing of the method for producing a wave plate of the implementation configuration.

FIG. 4B is a process drawing of the method for producing a wave plate of the implementation configuration.

FIG. 5 is a cross sectional view of the wave plate of the implementation configuration.

FIG. 6 is a view (1) for explaining the method for producing a wave plate of the implementation configuration by use of a metal mask.

FIG. 7 is a view (2) for explaining the method for producing a wave plate of the implementation configuration by use of the metal mask.

FIG. 8 is a view (3) for explaining the method for producing a wave plate of the implementation configuration by use of the metal mask.

FIG. 9 is a top view of a wave plate of a first embodiment.

FIG. 10 is a cross sectional view of the wave plate of the first embodiment.

FIG. 11 is an explanatory view of a method for producing a wave plate of the implementation configuration.

FIG. 12 is a correlation diagram of an X coordinate position, retardation, and an angle of a phase advance axis that are measured from the wave plate of the first embodiment.

FIG. 13 is a structural drawing of a transmitted spot evaluation device.

FIG. 14 is a photograph (1) of a transmitted spot of the wave plate of the first embodiment.

FIG. 15 is a photograph (2) of the transmitted spot of the wave plate of the first embodiment.

FIG. 16 is a photograph (3) of the transmitted spot of the wave plate of the first embodiment.

FIG. 17 is a top view of a wave plate of a second embodiment.

FIG. 18 is a cross sectional view of the wave plate of the second embodiment.

FIG. 19 is a correlation diagram of an X coordinate position, retardation, and an angle of a phase advance axis that are measured from the wave plate of the second embodiment.

FIG. 20 is a correlation diagram (1) of the X coordinate position, a spherical aberration of the wave plate of the second embodiment.

FIG. 21 is an explanatory view (1) of a method for measuring the spherical aberration.

FIG. 22 is a correlation diagram (2) of the X coordinate position, the spherical aberration of the wave plate of the second embodiment.

FIG. 23 is an explanatory view (2) of the method for measuring the spherical aberration.

FIG. 24 is a top view of a wave plate of a third embodiment.

FIG. 25 is a cross sectional view of the wave plate of the third embodiment.

FIG. 26 is a correlation diagram of an X coordinate position, retardation, and an angle of a phase advance axis that are measured from the wave plate of the third embodiment.

FIG. 27 is a correlation diagram of a wavelength and transmittance of the wave plate of the third embodiment.

FIG. 28 is a top view of a wave plate of a fourth embodiment.

FIG. 29 is a cross sectional view of the wave plate of the fourth embodiment.

FIG. 30 is a correlation diagram of the number of scanning lines of an irradiating laser beam in an X-axis direction and retardation Rd of the fourth embodiment.

FIG. 31 is a correlation diagram of the number of scanning lines of an irradiating laser beam in a Z-axis direction and retardation Rd of the fourth embodiment.

FIG. 32 is a diagram diagrammatically illustrating a retardation distribution in a birefringent region acquired as a result of a first region of a glass substrate being irradiated with a first laser beam by means of stationary irradiation technique and a second region of the glass substrate being irradiated with a second later beam by means of stationary irradiation technique.

FIG. 33 is a diagram diagrammatically showing a first mode of “stationary irradiation technique” of the invention.

FIG. 34 is a diagram diagrammatically showing a second mode of “stationary irradiation technique” of the invention.

FIG. 35 is a diagram diagrammatically showing a third mode of “stationary irradiation technique” of the invention.

FIG. 36 is a flowchart schematically showing an example of a method for producing a wave plate of the invention.

FIG. 37 is a diagram schematically showing an example of an apparatus employed in the method for producing a wave plate of the invention.

FIG. 38 is a graph showing a result of measurement of a retardation distribution appearing in birefringent regions along a first direction (a direction perpendicular to a direction in which laser spots of both groups of laser beams are arrayed) obtained in a fifth embodiment.

FIG. 39 is a graph showing a result of measurement of a retardation distribution appearing in birefringent regions along the first direction (the direction perpendicular to the direction in which laser spots of both groups of laser beams are arrayed) obtained in a sixth embodiment.

FIG. 40 is a graph collectively showing results of measurement of a retardation distribution in birefringent regions obtained at respective irradiation times along the first direction (the direction perpendicular to the direction in which the laser spots of both groups of laser beams are arrayed) in a seventh embodiment.

FIG. 41 is a graph collectively showing results of measurement of retardation distributions in the birefringent regions along the first direction (the direction perpendicular to the direction in which the laser spots of both groups of laser beams are arranged) achieved after first birefringent region formation processing and second birefringent region formation processing of an eighth embodiment.

### MODES FOR CARRYING OUT THE INVENTION

Modes for implementing the invention are hereunder described. In this regard, the same members, and the like, are assigned the same reference numerals, and their repeated explanations are omitted.

(Wave Plate)

A wave plate of the invention is now described. A thickness of a glass substrate employed for the wave plate of the invention ranges from 100 to 5000 μm. When the thickness of the wave plate is less than 100 μm, the wave plate might become brittle when produced or used. In contrast, when the thickness is 5000 μm or more, the wave plate is too thick and might be difficult to use from the viewpoint of a space and a mass. Soda lime glass, alkali glass, no-alkali glass, borosilicate glass, glass phosphate, lead glass, bismuth-based glass, synthetic quartz, and the like, are usable as a material of the glass substrate. Since it is preferable that the glass substrate be transparent from a visible range to a near infrared wavelength region, use of synthetic quarts and borosilicate glass of all is preferable. Since white sheet glass (soda lime glass exhibiting high transmittance) is inexpensive, use of the white sheet glass is more desirable. An example of white sheet glass is 3270 produced by SCHOTT GLAS.

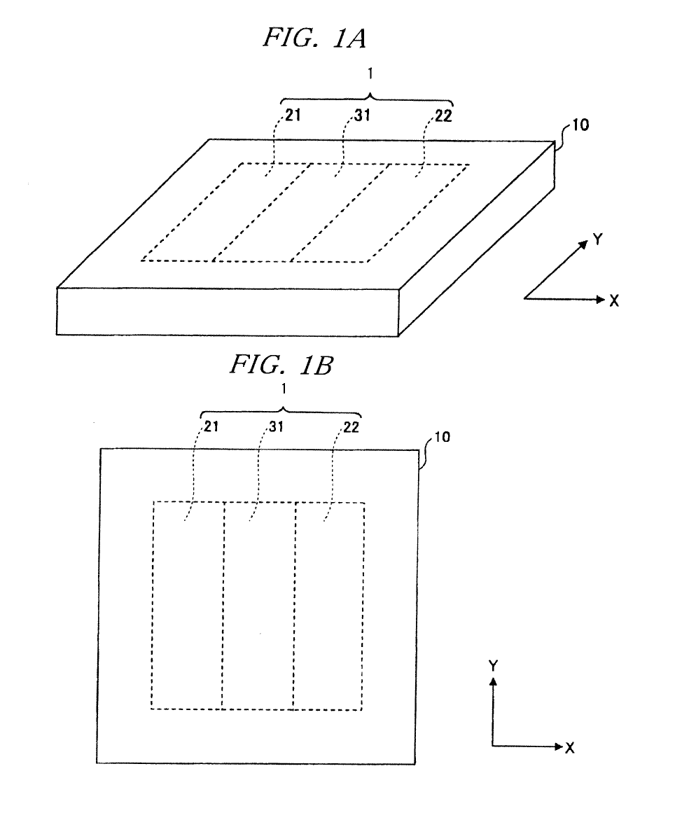

As shown in FIGS. 1A and 1B, a wave plate 1 of the invention has a first region 21, a second region 22, and a third region 31 formed on a glass substrate 10. The third region 31 is interposed between the first region 21 and the second region 22.

At least a portion of the first region 21 and a portion of the second region 22 exhibit uniaxial birefringence, and the first region 21 and the second region 22 are substantially parallel to each other in terms of a direction of a phase advance axis. Birefringence is a phenomenon in which a phase shift occurs depending on a direction of polarization during passage of polarized light. To be specific, a phase shift occurs between a polarized light component parallel to an axis called a phase advance axis along which a phase advances fast and a polarized light component perpendicular to the phase advance axis. The axis along which a phase lags is called a phase lag axis.

Further, uniaxial birefringence refers to a state in which phase advance axes or phase lag axes are aligned in one direction.

The expression “at least a portion of the first region 21 and a portion of the second region 22 exhibit uniaxial birefringence” means that, even when an area with a different direction of a phase advance axis or a phase lag axis is partially present, a region exhibits as a whole a specific direction of the phase advance axis. The expression “when viewed as a whole” also means that a direction of a phase advance axis is measured by letting coherent light enter an entire region. The phase advance axis of the first region 21 and the phase advance axis of the second region 22 are substantially parallel to each other when the regions are viewed as a whole.

The expression “substantially parallel” means that an angle between two axes falls within a range from −15 degrees to +15 degrees and, more preferably, a range from −5 degrees to +5 degrees. In the meantime, an expression “substantially orthogonal” means that an angle between two axes falls within a range from 75 degrees to 105 degrees and, more preferably, a range from 85 degrees to 95 degrees.

The third region 31 exhibits uniaxial birefringence, and a direction of a phase advance axis of the third region 31 is substantially orthogonal to the direction of the phase advance axis of the first region 21 and the direction of the phase advance axis of the second region 22. An area with a different direction of the phase advance axis or the phase lag axis does not even partially exist in the third region 31 in contrast to the first region 21 and the second region 22.

Incidentally, uniaxial birefringence of glass is created by stresses oriented in a particular direction. Although the first region 21 and the second region 22 exhibit uniaxial birefringence, the uniaxial birefringence derives from residual stresses aligned in a single direction. A direction of residual stresses existing in the first region 21 and a direction of residual stresses existing in the second region 22 are substantially parallel to each other.

Moreover, when an area with a different direction of the phase advance axis or the phase lag axis is partially present, a plurality of areas with a different direction of residual stresses are included in the first region 21 or the second region 22. However, the essential requirement for this case is that a total of residual stresses in the areas should be oriented in a specific direction.

In this regard, in general, when an area exhibiting residual stresses is present in glass, stresses also arise in surroundings of the area in glass because of the equilibrium of force (the law of action-reaction). In reality, the stresses assume a complicate distribution allowing for a three-dimensional balance and, hence, an analysis using a finite element method, or the like, is necessary. Simply, however, if stresses are tensile stresses, compressive stresses chiefly arise in the same direction. If stresses are compressive stresses, tensile stresses essentially arise in the same direction.

Since residual stresses are present in the first region 21 and the second region 22 as above, stresses also arise even in the third region 31, which is situated around them, because of the law of action-reaction. When the residual stresses that exist in the first region 21 and the second region 22 are tensile stresses aligned in a substantially parallel direction, the stresses that develop in the third region 31 primarily contain a component of compressive stresses that is substantially parallel to the direction of the residual stresses in the first region 21 and the second region 22.

Consideration is now given to a relationship between birefringence and stresses of glass. In general, a direction of stresses varies between a phase advance axis and a phase lag axis depending on whether stresses are tensile stresses or compressive stresses. Which stresses exhibit a phase advance axis is determined by a sign of a photoelastic coefficient. In glass, a phase advance axis arises in a direction of tensile stresses, and a phase lag axis arises in a direction perpendicular to the phase advance axis. Conversely, in the case of compressive stresses, a phase lag axis arises in a direction of the stresses, whilst a phase advance axis arises in a direction perpendicular to the phase lag axis.

Each of the first region 21 and the second region 22 partially includes an area where residual stresses still exist as above. The residual stresses are substantially parallel to each other and also parallel to a substrate surface. Consequently, the first region 21 and the second region 22 include each an area that exhibits uniaxial birefringence commensurate with the residual stresses. The phase advance axis of birefringence included in the first region 21 and the phase advance axis of birefringence included in the second region 22 are substantially parallel to each other and also parallel to the substrate surface.

When the residual stresses that still remain in the first region 21 and the second region 22 are tensile stresses, compressive stresses occur in the third region 31, and birefringence commensurate with the compressive stresses occurs. The stresses that develop in the third region 31 are compressive stresses that are aligned in one direction parallel to the substrate surface as above and substantially parallel to the direction of the stresses in the first region 21 and the second region 22. Consequently, birefringence which occurs in the third region 31 is uniaxial birefringence, and phase advance axes of the birefringence are aligned in one direction parallel to the substrate surface. Furthermore, phase lag axes occur in parallel with the compressive stresses, and hence the phase advance axes are substantially orthogonal to the direction of the compressive stresses.

Since the compressive stresses developed in the third region 31 are substantially parallel to the tensile stresses developed in the first region 21 and the second region 22, the phase advance axis of the third region 31 and the phase advance axes of the first and second regions 21 and 22 are substantially orthogonal to each other.

Therefore, the third region 31 assumes phase advance axes that are substantially orthogonal to the phase advance axes of birefringence of the first and second regions 21 and 22 and that act as a wave plate with respect to polarized light that passes through the third region 31.

As above, the area that exhibits uniaxial birefringence is provided in the first region 21 and the second region 22. The first and second regions 21 and 22 are substantially parallel to each other in a plane parallel to the substrate surface. Further, the third region 31 exhibits uniaxial birefringence, and phase advance axes of the third region 31 are characterized as being oriented in a direction that is substantially orthogonal to the phase advance axes of uniaxial birefringence of the first region 21.

The areas that include residual stresses and are present in the first region 21 and the second region 22 are formed by; for instance, irradiating a portion or entirety of each of the regions with a laser beam in a Y-axis direction in a scanning manner.

In the first region 21 and the second region 22 of the glass substrate 10, glass is temporarily heated by irradiation of the laser beam and then cooled; hence, tensile stresses that are parallel to the Y axis occur. In the area where a temperature has risen substantially in excess of a distortion point of glass, a refractive index n_{y} achieved in the Y-axis direction becomes lower than a refractive index nₓ achieved in the X-axis direction.

By means of irradiation of the laser beam, the first region 21 and the second region 22 come to include the areas that exhibit uniaxial birefringence. Moreover, in the other area where the temperature has not risen in excess of the distortion point of glass, uniaxial birefringence is not often induced. Even in such a case, when the first region 21 and the second region 22 are viewed as a whole, the regions can be deemed as having phase advance axes of uniaxial birefringence that are substantially orthogonal to the phase advance axes of the third region 31.

Means for inducing stresses in the first region 21 and the second region 22 may also be a method other than a laser scan. For instance, the means may also be implemented by stationary irradiation of a plurality of laser spots arrayed in the Y-axis direction or stationary irradiation of an elliptical laser beam whose major axis is oriented in the Y-axis direction. Stresses, such as those mentioned above, can be induced in the first region 21 and the second region 22 by means of, other than the laser, a contrivance for bringing a heat source; for instance, a heater, into contact with the first regions 21 and the second region 22, sufficiently heating the first regions, and causing a temperature gradient in the Y-axis direction in the course of being subsequently cooled.

Another conceivable specific method is to apply a glass frit material whose thermal expansion coefficient is different from that of the substrate 10 in a pattern of lines along the Y-axis direction over the surface of the substrate 10 including the first region 21 and the second region 22, to sufficiently heat and cool the first region 21, the second region 22, and the thus-applied glass frit material, and to induce various stresses in the first region 21 and the second region 22 by means of a difference in thermal expansion coefficient.

Another conceivable specific method is to sufficiently heat the first region 21 and the second region 22 and cool them while pressurizing the first region 21 and the second region 22 with means like mechanical pressing, thereby inducing stresses, such as those mentioned previously, in the first region 21 and the second region 22.

The direction of the residual stresses induced in the first region 21 and the second region 22 and the direction of birefringence incident to the residual stresses are not restricted to the X-axis direction and the Y-axis direction, such as those mentioned above. A function of a wave plate, which will be described later, can be fulfilled, so long as the residual stresses and birefringence are aligned in substantially parallel to the surface of the substrate.

Since the third region 31 is not irradiated with a laser beam, diffracted light and a wavefront aberration, which would otherwise occur in the first region 21 and the second region 22 for reasons of inconsistencies in irradiation of the laser beam, do not occur in the third region 31. When compared with the wave plate based on the technique described in connection with Patent Document 2, a resultant wave plate becomes optically consistent.

Moreover, since the wave plate of the invention is for varying a phase of incident light, a width of the third region 31 to be formed; namely, spacing between the first region 21 and the second region 22, becomes broader than a diameter of a beam spot of the incident light.

An example use of the wave plate of the invention is an optical system placed in a pickup of an optical disc. Optical discs include CDs, DVDs, Blu-rays, and others.

Since degradation of the wave plate of the invention attributable to irradiation of a pick-up laser beam is nominal, the wave plate is presumed to be built in surroundings of a laser light source, among others, of an optical system in a pickup. At this time, a diameter of the beam spot of light that enters the wave plate falls roughly within a range of about 10 to 100 μm.

Therefore, when the wave plate of the invention is used for the optical system in the pickup, a preferable diameter of the third region 31 is 100 μm or more. In consideration of a location margin for incorporation of an element, a more preferable diameter is 1 mm or more.

In this regard, retardation induced in the third region 31 is attributable to the residual stresses of the first region 21 and the second region 22 as above. However, if the spacing between the first region 21 and the second region 22; namely, the width of the third region 31, is excessively wide, the influence of the stresses of the first region 21 and the second region 22 on the third region 31 will be weakened, whereby resultant retardation Rd will become smaller. Thus, the performance of the wave plate might be impaired.

The retardation Rd is a value that represents performance of the wave plate. Specifically, the retardation Rd is represented by the following equation by means of an absolute value Δn of a difference between indices of components in polarized light passed through the wave plate, or a refractive index of a component parallel to the phase advance axis and a refractive index of another component perpendicular to the phase advance axis, and a thickness “t” of a birefringent area.

Rd=Δn×t

A state of polarization of the transmitted light can be regulated by adjusting the retardation Rd of the wave plate a desired level in accordance with a wavelength of transmitted light.

A preferable range of spacing between the first region 21 and the second region 22 to prevent impairment of performance of the wave plate is achieved depending on a glass material and processing conditions. When a common glass substrate, such as soda lime glass, is processed under preferable processing conditions to be described below, the spacing is preferably 50 mm or less, more preferably, 25 mm or less, and most preferably 10 mm or less.

Further, in order to induce uniform stresses in the third region 31 and make retardation, or the like, uniform, the first region 21 and the second region 22 should preferably be formed in a substantially parallel form. Moreover, a scan direction of irradiation of the laser beam scanned over the first region 21 and a scan direction of irradiation of the laser beam scanned over the second region 22 should preferably be substantially parallel to each other.

(Method for Producing a Wave Plate)

A method for producing a wave plate of the invention is now described.

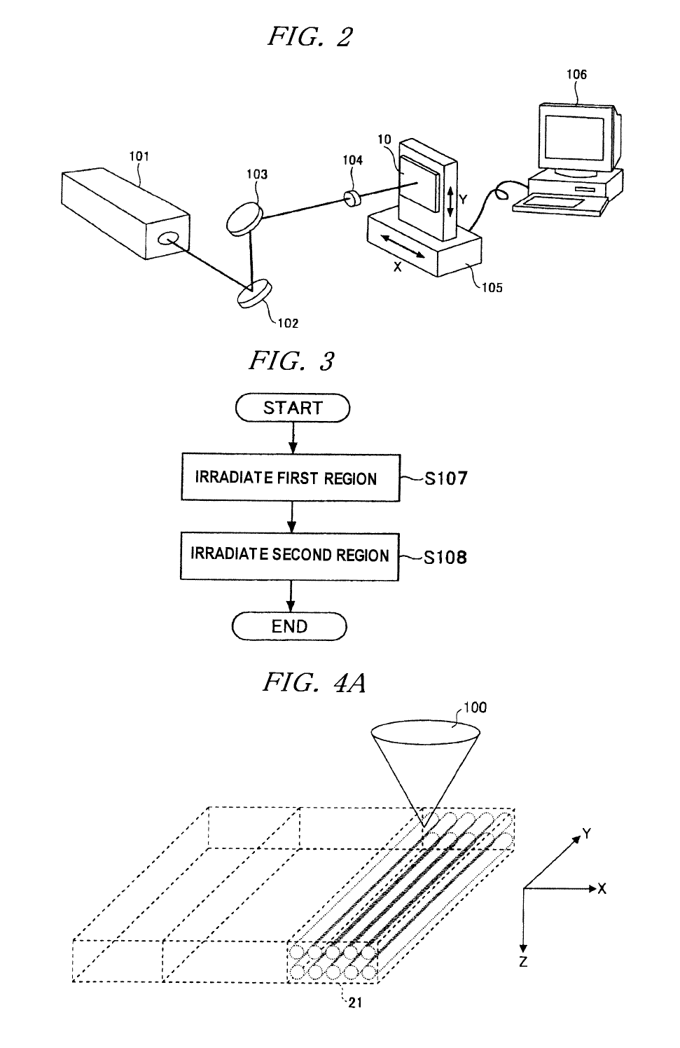

FIG. 2 is an example of a producing apparatus for producing a wave plate of the implementation configuration. To be specific, the producing apparatus has a light source 101 for emitting a laser beam, mirrors 102 and 103, a lens 104, an XY stage 105 on which the glass substrate 10 to be subjected to fabrication of a wave plate is placed, and a computer 106 for controlling the XY stage 105.

A UV-YAG laser that emanates a 355-nm laser beam is used for the light source 101. The beam emanated from the light source 101 is concentrated by the lens 104 by way of the mirrors 102 and 103 and applied to the glass substrate 10.

The glass substrate 10 can be moved in both directions X and Y by means of the XY stage 105, so that a desirable location on the glass substrate 10 can be irradiated with the laser beam. A method for irradiating the glass substrate 10 with a laser beam while the glass substrate 10 is moved in the Y-axis direction by means of the XY stage 105 is mentioned as; for instance, a method for radiating the laser beam while performing a scan in the Y-axis direction.

Although the implementation configuration describes a case where the UV-YAG laser is used as the light source 101, a laser beam having another wavelength can be used; for instance, a titanium sapphire laser, a green YAG laser (a wavelength of 532 nm), an excimer laser, like XeCl, a fundamental wave (a wavelength of 1064 nm) of the YAG laser, a fundamental wave (a wavelength of 1064 nm) of a YVO₄ laser, a double wave (a wavelength of 532 nm), or a triple wave (a wavelength of 355 nm), can also be used. In addition, a laser beam whose wavelength is appropriate for a material that makes up the glass substrate 10 is used.

Heat develops as a result of the laser beam being absorbed by the glass substrate 10 as above, and stresses develop in the glass when the substrate is later cooled. Therefore, the wavelength of the laser beam must be one that is appropriately absorbed by a material that makes up the glass substrate 10. When absorption is excessively great, only a surface of the substrate and its neighborhood are heated, so that stresses develop in the surface, which leads to unpreferable occurrence of defects, like fractures.

In contrast, when absorption is too little, the laser beam is not transformed into heat, so that unpreferably stresses for inducing sufficient retardation do not occur. An absorption coefficient (/mm) preferably ranges from 0.005 to 0.3 (an equivalent of 99 to 50% internal transmittance achieved at a thickness of 1 mm) and more preferably from 0.01 to 0.1 (an equivalent of 98 to 80% internal transmittance achieved at a thickness of 1 mm).

For instance, when common soda lime glass is used as a vitreous material, an absorption coefficient achieved at a wavelength of 1065 nm is 0.02 (/mm); hence, the soda lime glass can be employed in the implementation configuration in combination with the YAG laser that is a light source with the wavelength.

Light absorption can also be two-photon absorption. In this case, even when light absorption does not fall within the foregoing absorption range, the implementation configuration is fulfilled. For instance, when B270 (produced by SCHOTT GLAS) is used as a vitreous material, a UV-YAG laser with a wavelength of 355 nm is little absorbed. However, a laser beam is sometimes absorbed by gathering the laser beam with a lens of high power, and this laser beam can be used.

The laser beam is absorbed by the glass substrate 10 and thus transformed into heat as above, and stresses develop in the glass as a result of the glass substrate being cooled. Accordingly, conceivable measures are to adjust residual stresses by regulating power of the laser beam applied over the first region 21 and the second region 22 and control retardation Rd induced in the third region 31.

The power of a laser to be emitted denotes a total amount of energy of light, of an emitted laser, entering the glass substrate. If the intensity of the laser beam applied over the first region 21 and the second region 22 is too weak, the glass will not sufficiently be heated, and sufficient stresses will not develop. As a consequence, the performance of the wave plate will be impaired. On the contrary, if the intensity of the laser beam is too strong, resultant stresses will become too strong, or the laser beam will be absorbed on the substrate surface or surroundings thereof, which might cause fractures.

For these reasons, a preferable range of laser intensity is determined by a glass material, a processing apparatus, and the like. For instance, when a common glass substrate, such as soda lime glass, is irradiated with a laser beam having a wavelength of 355 nm, laser intensity preferably ranges from 0.02 W to 200 W, more preferably from 0.1 W to 50 W, and particularly preferably from 0.5 W to 20 W.

Since the stresses induced in the first region 21 and the second region 22 become greater with an increase in cooling speed, a contrivance of increasing the cooling speed after heating can also be made. Conceivable cooling methods include; for instance, a method for increasing heat dissipation by cooling the substrate 10 while a flat plate having large thermal conductivity, such as a metal plate, remains in contact with the substrate 10, a method for circulating a fluid, like a gas and cooling water, such that the fluid contacts the surface of the substrate 10, a method for providing a stage that retains the substrate 10 with electric cooling means, such as a Peltier element, and a method for increasing dissipation of heat from the substrate 10 by use of suction as retaining means for the stage that retains the substrate 10 to thus increase a degree of adhesion between the substrate 10 and the stage.

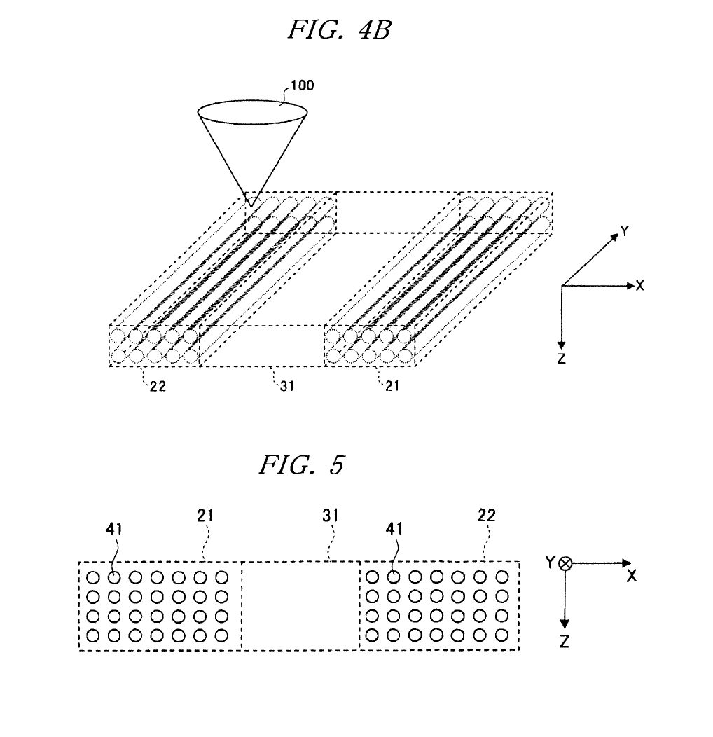

A method for producing the wave plate of the first implementation configuration is now described by reference to FIG. 3. First, in step 107 (S107), the first region 21 is irradiated with a laser beam 100 emanated from the light source 101. As shown in FIG. 4A, a scan is performed while the glass substrate 10 is irradiated with the laser beam 100 in a direction substantially parallel to the Y-axis direction. The scan is repeatedly performed in both the X-axis direction and a thicknesswise direction of the glass substrate 10 while a focal position of the laser beam 100 is being changed.

In step 108 (S108), the second region 22 that is apart from the first region 21 at a predetermined spacing is irradiated with the laser beam 100 emanated from the light source 101. As shown in FIG. 4B, the glass substrate 10 is irradiated with the laser beam 100 while being scanned in a direction substantially parallel to the Y-axis direction. In step 108, a scan is performed by means of irradiation of the laser beam 100 in a direction substantially parallel to the direction of the scan over the first region 21 by irradiation of the laser beam 100. The scan is repeatedly performed, as in the case with step 107, in both the X-axis direction and the thicknesswise direction of the glass substrate 10 while the focal position of the laser beam 100 is being changed.

As above, the retardation Rd induced in the third region 31 is attributable to the residual stresses of the first region 21 and the second region 22. Therefore, conceivable means for inducing desirable retardation Rd in the third region 31 is to control the residual stresses of the first region 21 and the second region 22. Conceivable means for controlling the residual stresses of the first region 21 and the second region 22 are to control a laser scan rate.

If a rate at which a scan over the first region 21 and the second region 22 is performed by a laser beam is too high, glass will not be sufficiently heated, and sufficient stresses will not develop. Thus, performance of the wave plate might be deteriorated. On the contrary, if the rate is too low, temperatures of surroundings of a point irradiated with the laser will become uniform because of heat diffusion. Since anisotropy of stresses commensurate with a scan will not sufficiently arise, the performance of the wave plate might not be sufficiently fulfilled.

A preferable range of the laser scan rate is determined by a glass material and a processing apparatus. For instance, when a common glass substrate, such as soda lime glass, is irradiated with a 3.2 W laser beam at a wavelength of 355 nm, a preferable range of a laser beam scan rate is 0.01 mm/sec. to 1000 mm/sec., a more preferable range of a laser beam scan rate is 0.05 mm/sec. to 250 mm/sec., and a particularly preferable range of a laser beam scan rate is 0.2 mm/sec. to 50 mm/sec.

Incidentally, as shown in FIG. 4A and FIG. 4B, a scan can be repeatedly performed, in steps 107 and 108, in both the X-axis direction and the thicknesswise direction (the Z-axis direction) of the glass substrate 10 while the focal position of the laser beam is being changed. A scan is performed a number of times in the thicknesswise direction by means of the laser beam as mentioned above, whereby the retardation Rd can be increased.

In relation to the thus-fabricated wave plate of the embodiment, as shown in FIG. 5, a scan line 41 of the laser beam caused by a scan performed in a direction substantially parallel to the Y-axis direction through irradiation is created in numbers at different locations, along the thicknesswise direction (Z-axis direction) of the glass substrate 10 and the X-axis direction, in the first and second regions 21 and 22. FIG. 5 illustrates an example in which a wave plate is fabricated in the third region 31 by making seven scans in the X-axis direction and four scans in the Z-axis direction.

Retardation induced in the third region 31 is attributable to the residual stresses in the first region 21 and the second region 22 as above. However, when a laser scan is performed while the X-axis direction or Z-axis direction of irradiation of the laser is being changed as means for controlling the residual stresses induced in the first region 21 and the second region 22, there is a preferable range of a scan pitch.

On the occasion of a repeated scan, when the area where the residual stresses are induced by irradiation of the laser is again heated by the next laser scan, the first induced residual stresses are eased by heat. For this reason, if a scan pitch is too small, stresses will not sufficiently be induced even when the number of laser scans is increased, so that a characteristic and production efficiency of the wave plate might not be sufficiently obtained.

In the meantime, when the scan pitch in the X-axis direction is too large, an area of the first region 21 and an area of the second region 22 become larger than an area of the third region 31. An element size required to acquire a desirable effective area of the wave plate becomes larger, so that the number of wave plates that can be fabricated per area of the substrate becomes small.

Moreover, when the scan pitch in the Z-axis direction is too large, the number of laser scans that can be performed per unit substrate thickness becomes smaller. The thickness of the wave plate required to induce sufficient stresses in the first region 21 and the second region 22 becomes great. The large size and the great thickness of the wave plate may worsen practical utility of module applications for which downsizing is desired, like a projector and an optical pickup. Further, the smaller number of wave plates per area of the substrate is unfavorable in view of a material cost.

Therefore, a scan pitch of the laser beam preferably ranges from 1 μm to 5000 μm, more preferably from 10 μm to 1000 μm, and particularly preferably from 50 μm to 200 μm.

Further, a conceivable method for simultaneously producing a plurality of wave plates on a glass substrate is to perform a laser scan by use of a metal mask that partially includes apertures. Compressive stresses develop in areas that exhibit a function of a wave plate, and tensile stresses develop in surroundings of the areas. The stresses might cause a problem of difficulty being encountered in processing for reasons of a skew in a dicing line or development of cracking. Stresses in a shielded area become smaller as a result of laser beams other than irradiation of the laser beams through the apertures being blocked at this time by use of the metal mask, which yields an advantage of ease of processing.

Any substance is available as a material for the metal mask, so long as the substance exhibits a superior light blocking effect. Stainless steel, aluminum, iron, and the like, can be mentioned as appropriate examples. Further, in relation to a thickness of the metal mask, if the mask is too thin, a problem will arise in terms of the light blocking effect. In contrast, if the mask is too thick, gathering a laser beam will be blocked by the mask. A preferable thickness of the metal mask ranges from about 0.1 mm to 1 cm.

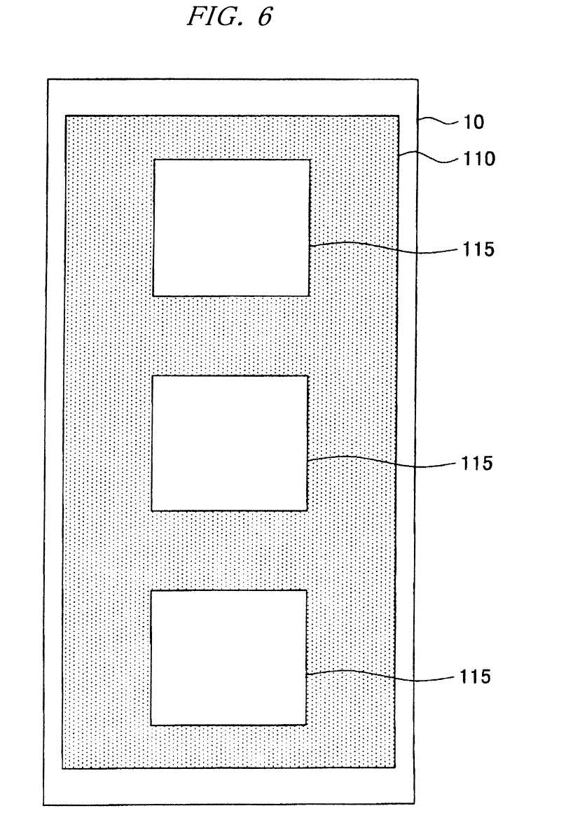

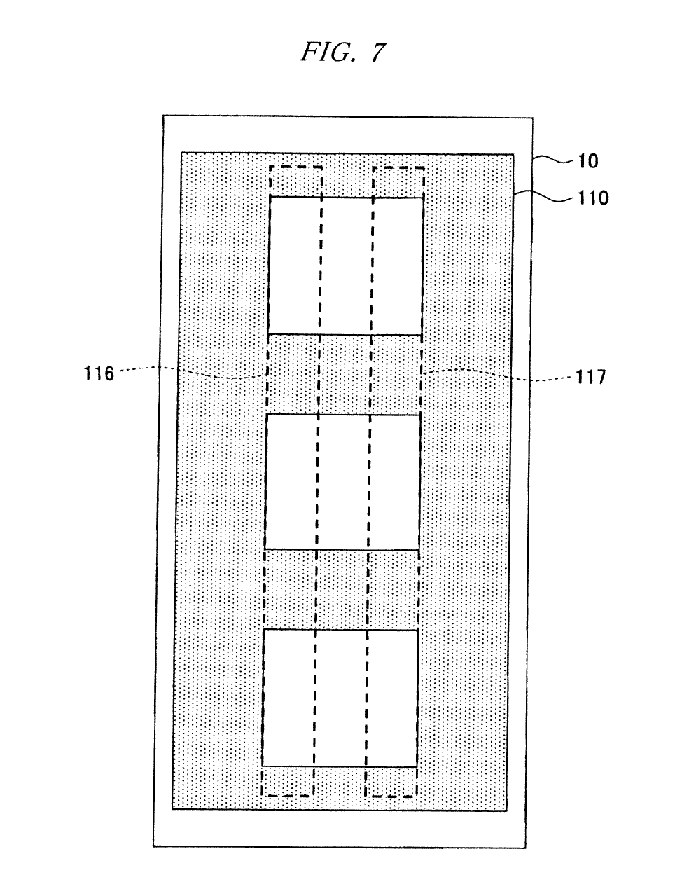

A processing method using the metal mask is now specifically described. As shown in FIG. 6, a metal mask 110 with a plurality of apertures 115 is placed on the glass substrate 10, and the glass substrate 10 and the metal mask 110 are fastened to each other. Next, as shown in FIG. 7, an area which is to become a first laser scan region 116 on the glass substrate covered with the metal mask is irradiated with the laser from above through the metal mask 110, performing a scan in the Y-axis direction. Likewise, an area which is to be a second laser scan region 17 on the glass substrate covered with the metal mask is irradiated with the laser beam from above through the metal mask 110, performing a scan in the Y-axis direction. The focal position of the laser is fixed to an interior of the glass substrate in connection with the Z axis.

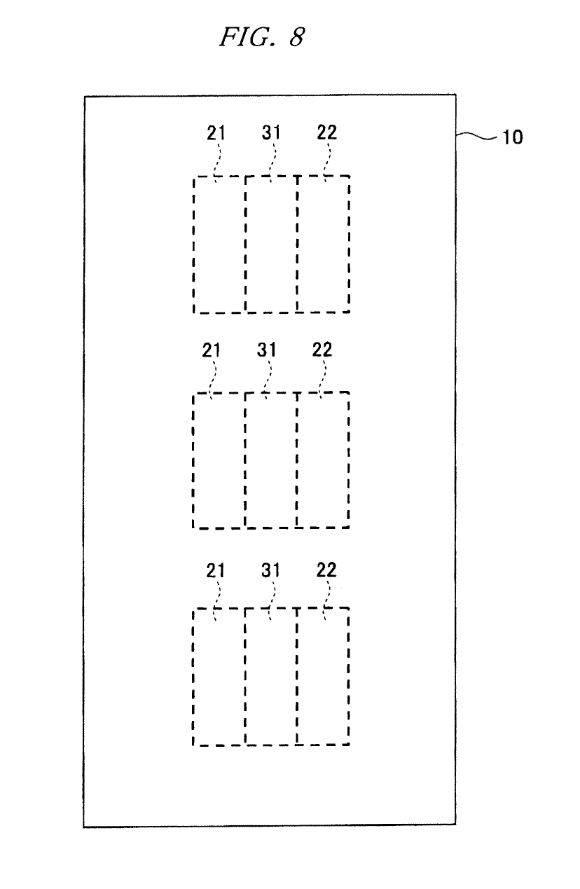

The metal mask 110 is taken away after performance of processing mentioned above, whereupon the first regions 21 and the second regions 22 are created, as shown in FIG. 8, at locations on the glass substrate 10 corresponding to the apertures 115 of the metal mask with the third regions 31 interposed therebetween. To be specific, a plurality of wave plates can be collectively fabricated on the glass substrate by use of the metal mask in the manner as mentioned above.

The wave plates of the first implementation configuration can be produced as above. Descriptions have been given thus far to the case where irradiating the first regions 21 with the laser beam and irradiating the second regions 22 with the laser beam are performed in turn. However, irradiating the first regions 21 with the laser and irradiating the second regions 22 with the laser can also be performed simultaneously. For instance, there is a method for dividing the laser beam by use of a diffraction optical element and a partially transparent mirror or employing a plurality of lasers.

A second implementation configuration is a method for producing a wave plate, comprising:

(a) preparing a glass substrate; and

(b) subjecting the first regions on the glass substrate and the second regions spaced apart from the respective first regions to stationary irradiation of the laser beam.

A first peak of a retardation value and a second peak of a retardation value thereby appear in the first regions and the second regions, respectively, and a peak or a flat part of the retardation value appears in the third regions interposed between the first and second regions.

Under the producing method, the laser beam is radiated on predetermined locations on the glass substrate, and stays as it is in its position. Specifically, the laser beam remains fixed with respect to the glass substrate and does not perform a scan. Therefore, under the method, a problem of variations due to a laser beam scan does not occur.

Accordingly, under the method, a high degree of reproducibility is achieved in connection with a state of fabrication of a birefringent region. Variations in a state of a birefringent area can be significantly inhibited in each producing process.

Under the producing method of the invention, there is adopted a technique of irradiating, in a stationary manner, the first regions on the glass substrate and the second regions spaced apart from the respective first regions with the laser beam. Under such a “stationary irradiation technique” (a laser beam irradiation technique unique to the invention is hereunder referred to particularly as a “stationary irradiation technique”), the third regions including the birefringent regions are fabricated between the respective first regions and the corresponding second regions that are exposed to the laser beam.

By reference to the drawings, this phenomenon is hereunder described in detail.

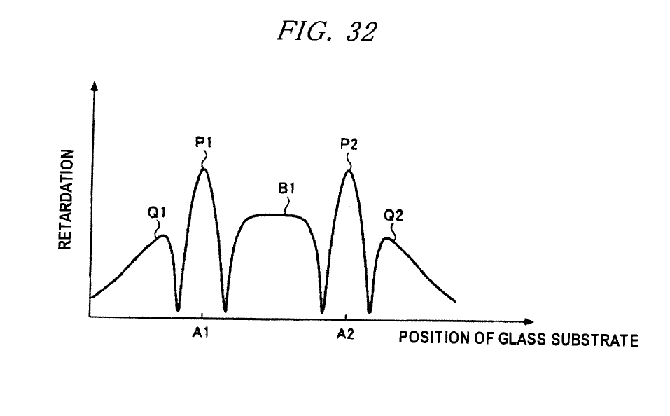

FIG. 32 diagrammatically shows a retardation distribution in birefringent regions that are fabricated by irradiating the first regions on the glass substrate with a first laser beam in a stationary manner and irradiating the second regions on the glass substrate with a second laser beam in a stationary manner.

In FIG. 32, a horizontal axis represents locations on the glass substrate, whereas a vertical axis represents retardation values. A coordinate point A1 on the horizontal axis corresponds to the first regions on the glass substrate; namely, a location exposed to the first laser beam. A coordinate point A2 on the horizontal axis corresponds to the second regions on the glass substrate; namely, a location exposed to the second laser beam. A first peak P1 of the retardation value appears in the first region (the coordinate A1) on the glass substrate that is exposed to the first laser beam. A second peak P2 of the retardation value appears in the second region (the coordinate A2) on the glass substrate that is exposed to the second laser beam. A flat part B1 of the retardation value appears in the third regions (between the coordinate A1 and the coordinate A2) between the first respective regions and the corresponding second regions.

As is obvious from FIG. 32, the retardation distribution shows the large two peaks, or the peak P1 (the first peak) and the peak P2 (the second peak), and the one flat part B1 located between the two peaks, in the birefringent regions of each of the wave plates produced under the method of the invention. Further, a small peak Q1 (a first small peak) arises outside the first peak P1, and a small peak Q2 (a second small peak) arises outside the second peak P2.

Such a retardation distribution can be readily acquired by birefringence measurement with use of a polarization microscope or a birefringence measurement apparatus.

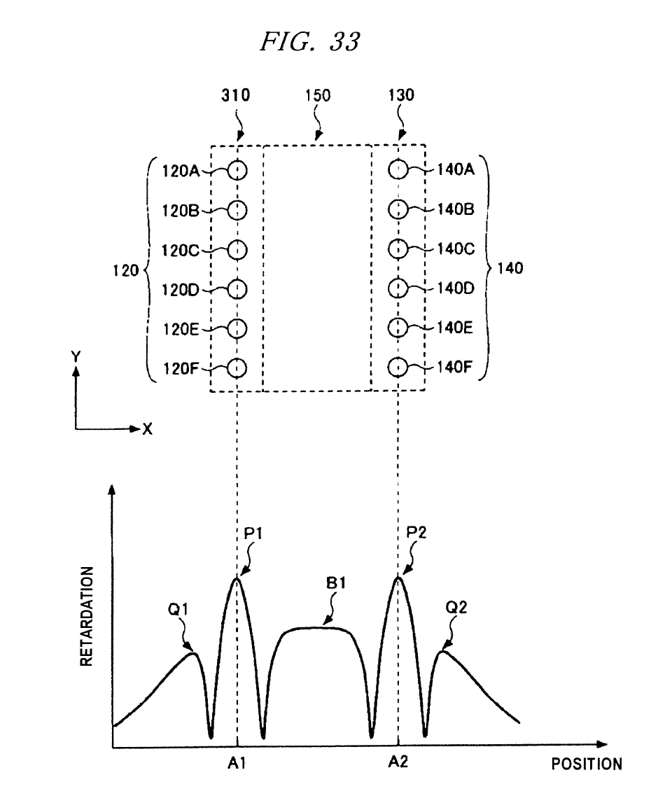

FIG. 33 diagrammatically shows a first mode of “stationary irradiation technique” of the invention. For the sake of reference, a retardation distribution corresponding to locations on the glass substrate, such as that shown in FIG. 32, is provided in a lower portion of FIG. 33 in conjunction with the first mode of the stationary irradiation technique.

As shown in FIG. 33, in the first mode, a first laser beam group 120 is radiated in a stationary manner on a first region 310 on the glass substrate 10, and a second laser beam group 140 is radiated in a stationary manner on a second region 130.

The peak P1 of the retardation value thereby appears in the first region 310, and the peak P2 of the retardation value appears in the second region 130. Further, a third region 150 including the flat part B1 (or the peak, the same also applies to any counterparts in the followings) of the retardation value is formed between the first region 310 and the second region 130. Moreover, a first small peak Q1 appears on an outside of the first region 310; namely, on the other side of the flat part B1. Further, a second small peak Q2 appears on the outside of the second region 130, or on the other side of the flat part B1.

In a mode shown in FIG. 33, the first laser beam group 120 is made up of six laser spots 120A to 120F. The second laser beam group 140 is also made up of six laser spots 140A to 140F. However, the number of laser spots that make up each of the laser beam groups 120 and 140 is not particularly limited. For instance, each of the laser beam groups 120 and 140 can also be made up of a single laser spot. In this regard, an entire length of the third region 150 (i.e., the length of the third region in the direction Y) can be broadened by increasing the number of laser spots in each of the regions 310 and 130.

Further, in the example shown in FIG. 33, each of the laser spots 120A to 120F and 140A to 140F assumes a substantially circular shape and an identical diameter. However, these are a mere example. At least one of the laser spots 120A to 120F and 140A to 140F can be; for instance, linear (to be more specific, rectangular) or elliptical. In addition, the respective spots can assume different diameters.

In the example shown in FIG. 33, the laser beams making up the respective laser spots 120A to 120F and 140A to 140F assume the same intensity. However, this is not always a requisite, and the intensity of the laser beam can be changed on a per-spot basis. For instance, the intensity of the spots of the first laser beam group 120 is varied consecutively or stepwise such that the laser spots at respective ends (120A and 120F) of the line have higher intensity. The same also applies to the second laser beam group 140.

When the laser spots 120A to 120F in the first laser beam group 120 are presumed to have the same intensity, thermal effects caused by the respective laser spots are superimposed at a line-wise center area of the first region 310 (i.e., a center area along the direction Y). Therefore, a greater heat effect is achieved with an increasing approach toward the line-wise center of the first region 310. However, when the spots (120A and 120F) at the respective ends of the line are arrayed so as to have greater intensity, a degree of thermal effects achieved in the line-wise direction of the first region 310 is made uniform. A uniform retardation distribution can be acquired along the line-wise direction of the first region 310. The same also applies to the second region 130.

The respective laser spots 120A to 120F that make up the first laser beam group 120 are arrayed along one direction (the direction Y), and this is not always a requisite. For instance, the laser spots 120A to 120F can also be arrayed in a zigzag pattern. The laser spots 120A to 120F of the first laser beam group 120 and the corresponding laser spots 140A to 140F of the second laser beam group 140 can preferably be arrayed symmetrical about the third region 150. Uniformity of the retardation distribution in the third region 150 is thereby enhanced.

When the laser spots 120A to 120F and 140A to 140F are linear or elliptical, the laser spots 120A to 120F and 140A to 140F can also be arrayed such that a major axis of each of the linear or elliptical spots is in parallel with the arrayed direction of the laser spots (i.e., the direction Y in the example shown in FIG. 33). In this case, when compared with a case where all circular laser spots are arrayed in one direction, the number of spots can be diminished.

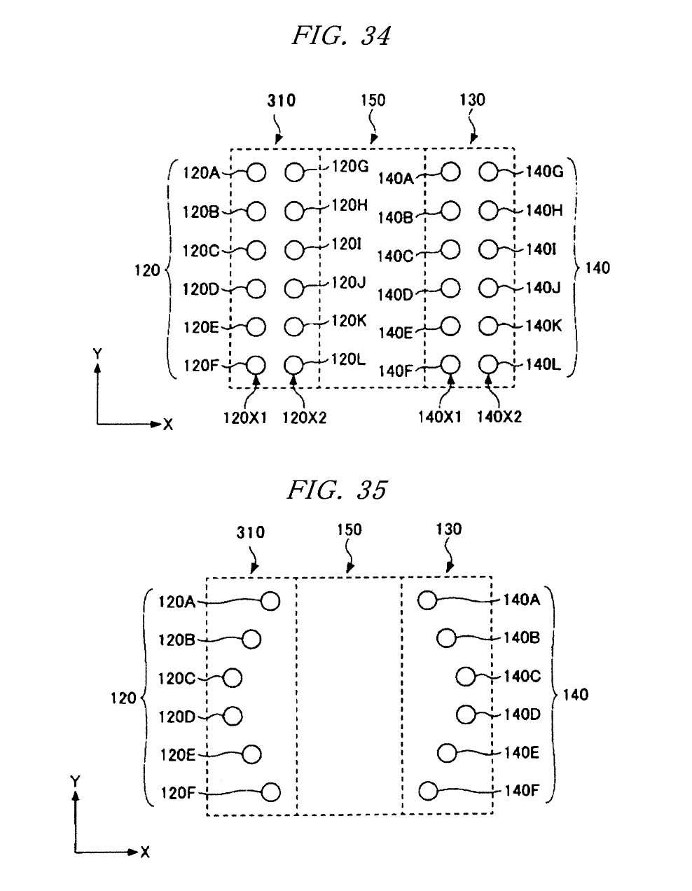

FIG. 34 diagrammatically shows a second mode of the “stationary irradiation technique” of the invention. As shown in FIG. 34, in contradistinction with the first mode, in the second mode the laser spots 120A to 120L that make up the first laser beam group 120 are arrayed in two lines, a line 120X1 and a line 120X2. Likewise, the laser spots 140A to 140L that make up the second laser beam group 140 are arrayed in two lines, a line 140X1 and a line 140X2.

The laser spots that make up the first laser beam group 120 and the second laser beam group 140 can also be arrayed in two lines or more as above.

In the second mode, the width of each of the first region 310 and the second region 130 achieved in the direction X (in other words, the width of the third region) can be made wide, so that wider birefringent regions can be fabricated along the direction X.

Even in this mode, when the laser spots 120A to 120L and 140A to 140L are linear or elliptical, the laser spots 120A to 120L and 140A to 140L can also be arrayed such that a major axis of each of the linear or elliptical spots is in parallel with the arrayed direction of the laser spots (i.e., the direction Y in the example shown in FIG. 4). In this case, when compared with a case where all circular laser spots are arrayed in one direction, the number of spots can be diminished.

FIG. 35 diagrammatically shows a third mode of the “stationary irradiation technique” of the invention.

As shown in FIG. 35, in contradistinction with the first mode, in the third mode the laser spots 120A to 120F that make up the first laser beam group 120 are not arrayed in line along the direction Y. Specifically, the laser spots 120A to 120F which make up the first laser beam group 120 are arrayed such that laser spots nearer to the line-wise center (e.g., 120C and 120D) become further away from the second region 130. Likewise, the laser spots 140A to 140F which make up the second laser beam group 140 are arrayed such that laser spots nearer to the line-wise center (e.g., 140C and 140D) become further away from the first region 110.

In such a third mode, areas thermally affected by the respective laser spots 120A to 120F are more uniformly spread in a two-dimensional way (in the directions X and Y) within the first region 110. Areas thermally affected by the respective laser spots 140A to 140F are more uniformly spread in a two-dimensional way (in the directions X and Y) within the second region 130. Resultantly, the entire length of the third region 150 (i.e., the length achieved along the direction Y) can be increased further.

By reference to FIGS. 33 to 35, the example modes of the “stationary irradiation technique” of the invention have been described above. It is, however, manifest to those who are skilled in the art that the modes are mere examples and that other various modes of the “stationary irradiation technique” will be present.

For instance, in all of the foregoing example modes, the first region 310 at a first depth of the glass substrate 10 is irradiated in a stationary manner with the first laser beam group 120, and the second region 130 at the first depth of the glass substrate 10 is irradiated in a stationary manner with the second laser beam group 140, whereby the third region 150 is fabricated. However, for instance, the first depth of the glass substrate can also be irradiated with the first and second laser beam groups in a stationary manner (first birefringence formation processing), and a second depth of the glass substrate can also be irradiated in the same manner in the stationary way (second birefringence region formation processing). In this case, when the glass substrate is viewed in its thicknesswise direction, the location irradiated with the first and second laser beam groups in the first birefringence region formation processing and the location irradiated with the first and second laser beam groups in the second birefringence region formation processing can also be substantially coincident with each other.

In such a mode in which birefringence region formation processing is repeated twice or more at the respective depth of the glass substrate, the behavior of retardation distribution, such as that shown in FIG. 32, becomes more noticeable, and a region having a larger retardation value can be fabricated in the center (the third region) of the birefringent region.

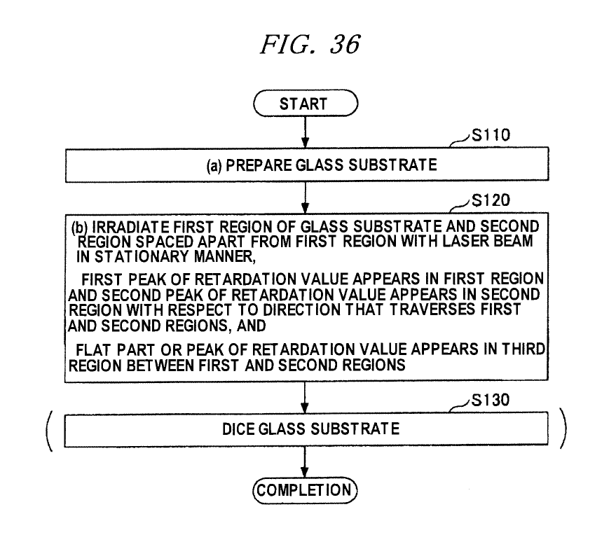

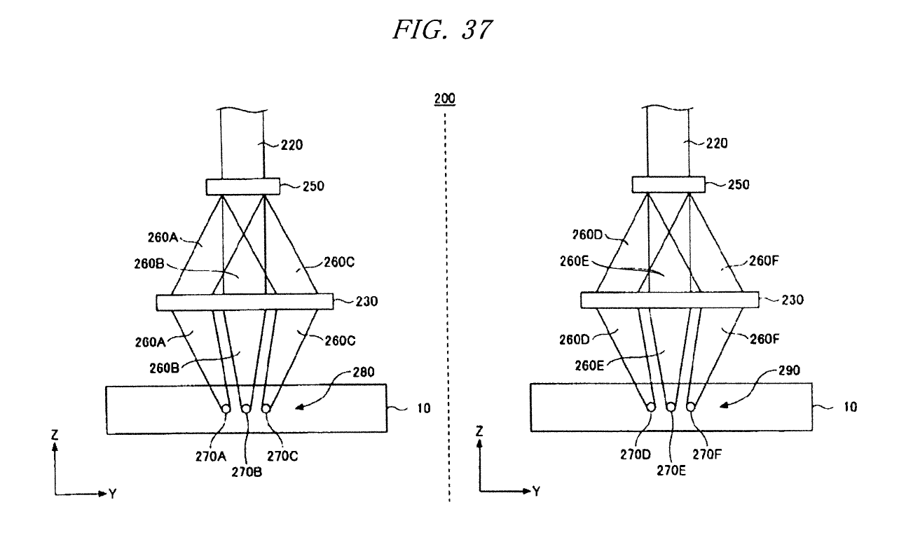

By reference to FIGS. 36 and 37, the method for producing the wave plate by the “stationary irradiation technique” of the invention is described more specifically.

FIG. 36 shows a schematic flowchart of an example of the method for producing a wave plate by the “stationary irradiation technique” of the invention. FIG. 37 shows an example of an apparatus utilized in the method for producing a wave plate by the “stationary irradiation technique” of the invention.

As shown in FIG. 36, the method for producing a wave plate by the “stationary irradiation technique” of the invention comprising:

(a) a step (step S110) of preparing a glass substrate; and

(b) a step (step S120) of radiating a laser beam, in a stationary manner, on a first region of the glass substrate and a second region spaced apart from the first region, whereby a first peak of retardation value appears in the first region, a second peak of retardation value appears in the second region, and a peak or flat part of retardation value appears in a third region between the first and second regions.

The method further includes, when necessary,

(c) a step (step S130) of dicing the glass substrate.

FIG. 37 shows an example of the apparatus utilized in the method for producing a wave plate by the “stationary irradiation technique” of the invention.

As shown in FIG. 37, an apparatus 200 utilized in the method for producing a wave plate by the “stationary irradiation technique” of the invention is equipped with a laser beam 220 emanated from a laser light source (not shown), a diffraction optical element 250 that divides the laser beam 220 into a plurality of branch laser beams 260A to 260F; and a lens 230 that condenses the branch laser beams 260A to 260F to a desirable location on the glass substrate 10.

The branch laser beams 260A to 260C are radiated on a first region 280 of the glass substrate 10, and the branch laser beams 260D to 260F are radiated on a second region 290 of the glass substrate 10. Since this mode cannot be clearly illustrated by a single side elevation, the branch laser beams 260A to 260C radiated on the first region 280 and the branch laser beams 260D to 260F radiated on the second region 290 are separately illustrated in FIG. 37.

Although not particularly limited, the laser light source for the laser beam 220 can also be an excimer laser light source (XeCl: a wavelength of 308 nm, Krf: a wavelength of 248 nm, or ArF: a wavelength of 193 nm), a YAG laser light source (a wavelength of 1064 nm), a YVO₄ laser light source (a wavelength of 1064 nm), a titanium sapphire laser light source (a wavelength of 800 nm), or a carbon dioxide gas laser light source (a wavelength of 10.6 μm), or the like. In addition to the fundamental waves, a double wave laser beam or a triple wave laser beam; for instance, can be used as the YAG laser light source and the YVO₄ laser light source. The double wave YAG laser has a wavelength of 532 nm, and the triple wave YAG laser has a wavelength of 355 nm.

Power of the laser light source is not particularly limited. The greater the power of the laser light source, a larger number of branch laser beams can be obtained at one time. This is advantageous for expansion of a birefringent region.

The diffraction optical element 250 can be embodied by any element, so long as the element can divide the single laser beam 220 into the plurality of branch laser beams 260A to 260F. For instance, a beam splitter, or the like, can be used in place of the diffraction optical element.

Processes of the producing method of the invention are hereunder described in detail in association with operation of the apparatus 200 shown in FIG. 37.

(Step S110)

The glass substrate 10 used for making up the wave plates is first prepared.

A composition of the glass substrate 10 is not particularly limited. The glass substrate 10 can be; for instance, soda lime glass, borosilicate glass, and silica glass. In the invention, in order to increase an absorption coefficient achieved at a wavelength of the laser beam 220 to be used, glass doped with transition metal can also be used as the glass substrate 10.

A thickness of the glass substrate is not particularly limited. The thickness of the glass substrate may range from; for instance, 0.1 mm to 3 mm.

(Step S120)

Next, the laser beam 220 is emitted to the glass substrate 10 from the laser light source. The diffraction optical element 250 divides the laser beam 220 into; for instance, the six branch beams 260 (260A to 260F).

The branch beams 260A, 260B, and 260C are gathered by the lens 230, whereby laser spots 270A, 270B, and 270C are respectively formed on the first region 280 in the glass substrate 10. The laser spots 270A, 270B, and 270C can also be arrayed in a straight line.

Likewise, the branch beams 260D, 260E, and 260F are gathered by the lens 230, whereby laser spots 270D, 270E, and 270F are respectively formed on the second region 290 in the glass substrate 10. The laser spots 270D, 270E, and 270F can also be arrayed in a straight line. In this respect, a depth of the first region 280 from the surface of the glass substrate 10 and a depth of the second region 290 from the surface substantially accord with each other.

In the example shown in FIG. 37, three laser beams are focused on the first and second regions 280 and 290. However, the number of laser spots is arbitrary.

Moreover, in the example shown in FIG. 37, all of the branch beams 260A to 260F are gathered by the single lens 230. However, one lens can be used for the branch beams 260A to 260C to be gathered to the first region 280, and another lens can be used for the branch beams 260D to 260F to be gathered to the second region 290.

Although a diameter of laser spots of the respective focal points 270A to 270F varies according to performance of the lens 230, or the like, the diameter can range; from 0.1 μm to 100 μm (e.g., 0.5 μm).

In each of the regions 280 and 290, a pitch between the laser spots is not particularly limited. However, from the viewpoint of restrictions on the configuration of the apparatus, a realistic pitch preferably ranges from 20 μm to 40 μm and preferably from 50 μm to 250 μm.

As above, in the invention, the branch beams 260A to 260C to be radiated on the first region 280 and the branch beams 260D to 260F to be radiated on the second region 290 are all radiated by the stationary irradiation technique and not subjected to scanning. As a result, the third region is thereby created between the first region 280 and the second region 290. The birefringent region that exhibits a retardation distribution, such as that shown in, for instance, FIG. 32, can be fabricated in its entirety.

Irradiating the first region 280 of the glass substrate 10 with the branch beams 260A to 260C and irradiating the second region 290 with the branch beams 260D to 260F do not always need to be performed concurrently. For instance, the first region 280 of the glass substrate 10 may be irradiated with the branch beams 260A to 260C, to thus induce the peak P1 of large retardation value, such as that shown in FIG. 33, in the first region 280. Subsequently, the second region 290 may be irradiated with the branch beams 260D to 260F, to thus induce the peak P2 of large retardation value, such as that shown in FIG. 33, in the second region 290. Moreover, for instance, after the first region 280 is irradiated with one branch beam (e.g., the branch beam 260A), the second region 290 is irradiated with another branch beam (e.g., the branch beam 260D). Thus, the laser beam can also be alternately radiated to the first region 280 and the second region 290.

A width of the third region fabricated between the first region 280 and the second region 290 (i.e., a distance between the first region 280 and the second region 290) is not particularly limited. However, in order to increase the width of the third region, it is necessary to increase the laser power of each of the branch beams or use laser beams arrayed in a plurality of lines, such as that shown in FIG. 34, for each of the regions 280 and 290. When a line of laser beams is radiated to each of the regions 280 and 290, the width of the third region is usually 10 mm or less. The width of the third region is; for instance, 0.1 mm to 2 mm.

(Step S130)

The wave plate having the glass substrate on which the birefringent region is fabricated can be obtained through the above steps.

However, when there is a necessary for a compact wave plate, processing pertaining to a step of cutting (dicing) the glass substrate 10 can additionally be performed when necessary.

On this occasion, it is preferable to cut the glass substrate 10 such that a cutting line passes through areas corresponding to the small peaks Q1 and Q2 of retardation values in the birefringent regions. The compressive stresses still remain in the areas corresponding to the small peaks Q1 and Q2 as above. For this reason, when the wave plate is diced at such locations, fractures or cracking in a cut area, which would otherwise occur during cutting, can be significantly inhibited. Moreover, the compressive stresses are present in the end faces of the wave plate, a high strength wave plate can be obtained.

The producing method of the invention has been described in the above by taking, by way of example, the case where the three branch laser beams arrayed in the straight line along the direction Y are radiated on each of the first and second regions 280 and 290.

However, as mentioned above, attention must be paid to the fact that various modes are conceivable as a mode employed at the time of irradiation of laser beams on the first region 280 and the second region 290 (especially as an array of laser spots). Further, processing pertinent to step S120 is repeated at different depths of the glass substrate 10, whereby a region having a larger retardation value can be fabricated in the center of the birefringent region (i.e., the third region) as above.

### First Embodiment

A wave plate of an implementation configuration that is to serve as a first embodiment is now described. The wave plate of the embodiment uses a slide glass S1112 produced by Matsunami Glass Ind. Ltd. as the glass substrate 10 that has a size of 76 mm×26 mm and a thickness of 1.0 mm.

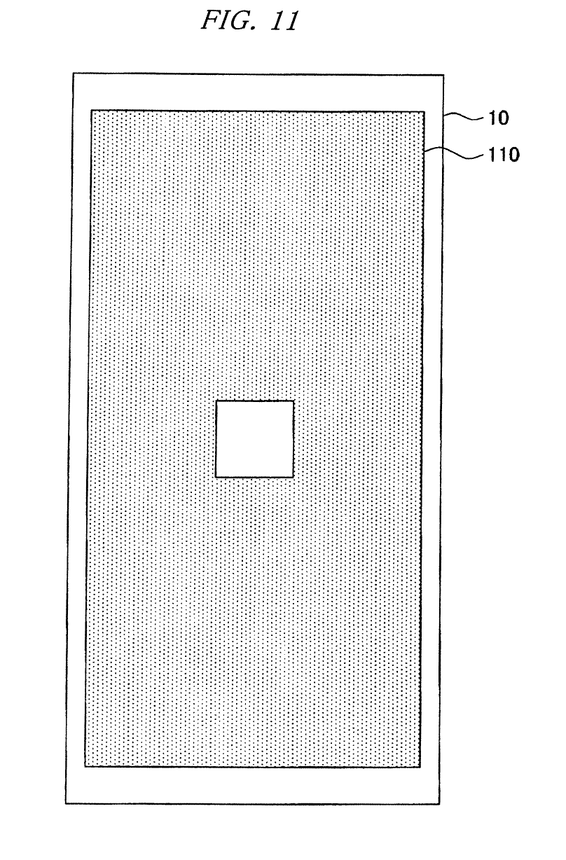

The first region 21 and the second region 22 are fabricated in a region spaced, by 2.7 mm, away from either side of an aperture of a metal mask to be described later, and the third region 31 is fabricated between the first region 21 and the second region 22 so as to have a width of 2.0 mm. To be specific, as shown in FIG. 11, the metal mask 110 with an aperture measuring 7 mm×7.4 mm is fixedly placed on a surface of the glass substrate 10 to be exposed to a laser beam.

Next, the lens is placed such that the laser beam is gathered to an interior of glass, and the laser beam is radiated on the glass substrate from the direction of the metal mask. Since the substrate is irradiated with the laser beam only when the aperture of the metal mask is scanned by the laser beam, the first region 21 and the second region 22 are fabricated in an area of the glass substrate corresponding to the aperture of the metal mask. Further, since the third region 31 is located between the first region 21 and the second region 22, the third region 31 is also fabricated in an area of the glass substrate corresponding to the aperture of the metal mask.

The glass substrate is shifted in the Y-axis direction shown in FIG. 11 while a positional relationship is maintained such that a constant focal distance exists between the substrate surface and the laser, thereby performing a scan with the laser beam.

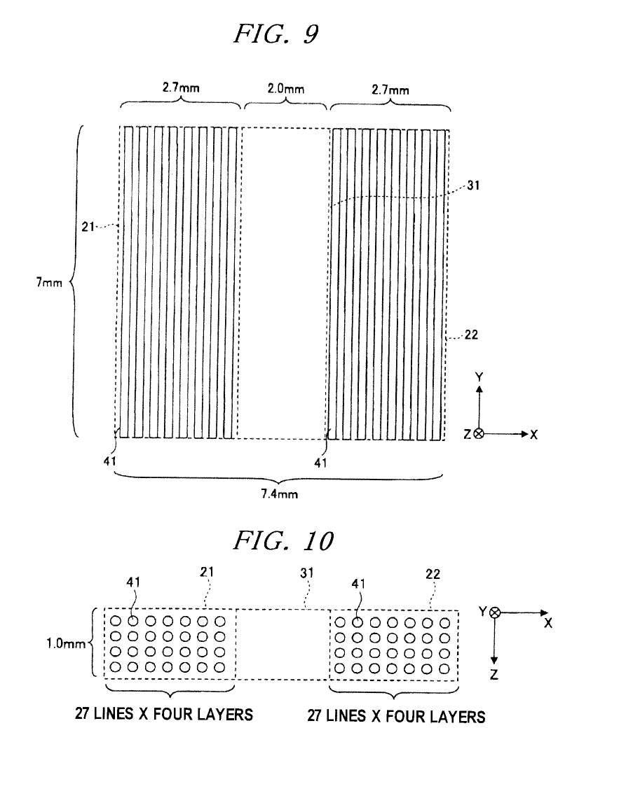

Next, the focal position is shifted in the X-axis direction by 100 μm, and a scan is likewise performed in the Y-axis direction with the laser beam. The operation is iterated 27 times, thereby enlarging an area on the glass substrate where stresses develop. The same also applies to the direction Z; in other words, the focal point is shifted by 100 μm in the Z-axis direction, to thus perform a scan with the laser beam in the Y-axis direction. The operation is iterated four times, thereby enlarging a region in the glass substrate where stresses develop in its thicknesswise direction. Through the operations, a total of 108 scan lines are created; namely, the scan line 41 is created in the number of 27 along the X-axis direction, and four layers of the scan lines 41 are created in the Z-axis direction. As shown in FIGS. 9 and 10, scans are performed while irradiation of the laser beam is performed, whereby the first region 21 and the second region 22 are fabricated.

The laser beam used for irradiation has a wavelength of 355 nm and power of 3.2 W, and a scan rate of the laser beam used for irradiation is 20 mm/sec. FIG. 9 is a top view of the wave plate of the embodiment, and FIG. 10 is a cross sectional view of the same. Portions of the scan lines 41 are often omitted from drawings, including FIGS. 9 and 10.

FIG. 12 shows a relationship among positions on the wave plate of the embodiment in the X-axis direction, retardation Rd caused by light having a wavelength of 546 nm, and angles of the phase advance axis. In the embodiment, the first region 21 of the wave plate is placed with X coordinates that range from 500 μm to 3200 μm; the second region 22 of the wave plate is placed with X coordinates that range from 5200 μm to 7900 μm; and the third region 31 of the wave plate is placed with X coordinates that range from 3200 μm to 5200 μm.

As shown in FIG. 12, when the X-coordinate position of the third region 31 is around 4000 μm, retardation Rd of about 100 nm is obtained. Since the glass material does not exhibit any remarkable absorption with respect to visible light, a resonance frequency defined by the Kramers-Kronig relations does not stand. Wavelength dispersion of a refractive index observed in a range from a wavelength of 546 nm to a wavelength of 400 nm at which evaluation is practiced in the embodiment is sufficiently small. For this reason, the refractive index of the glass acquired at a wavelength of 546 nm and the refractive index of the glass acquired at a wavelength of 400 nm can be deemed to be substantially identical with each other.

The retardation Rd is a quantity that is determined by a refractive index and the thickness of the glass substrate. In relation to a measurement result of retardation Rd shown in FIG. 12, a retardation value is considered to be substantially identical with regard to blue light having a wavelength of about 400 nm. Therefore, the wave plate of the embodiment acts as a quarter-wave plate with respect to blue light having a wavelength of about 400 nm.

An angle of the phase advance axis is about 90 degrees in the first region 21 and the second region 22, whilst an angle of the phase advance axis in the third region 31 is about 0 degree. Since the direction of the phase advance axis in the third region 31 is aligned, uniaxial birefringence can be ascertained. Since the third region 31 exhibits uniaxial birefringence, the third region 31 acts as a wave plate. Further, the first region 21 and the second region 22 exhibit uniaxial birefringence, and the phase advance axes of the first and second regions are understood to be orthogonal to the phase advance axis of the third region 31.

In relation to the angle of the phase advance axis, a direction perpendicular to the Y-axis direction is taken as 0 degree. The same also applies to any counterpart in the following embodiments.

A beam spot made by the wave plate of the embodiment is now described.

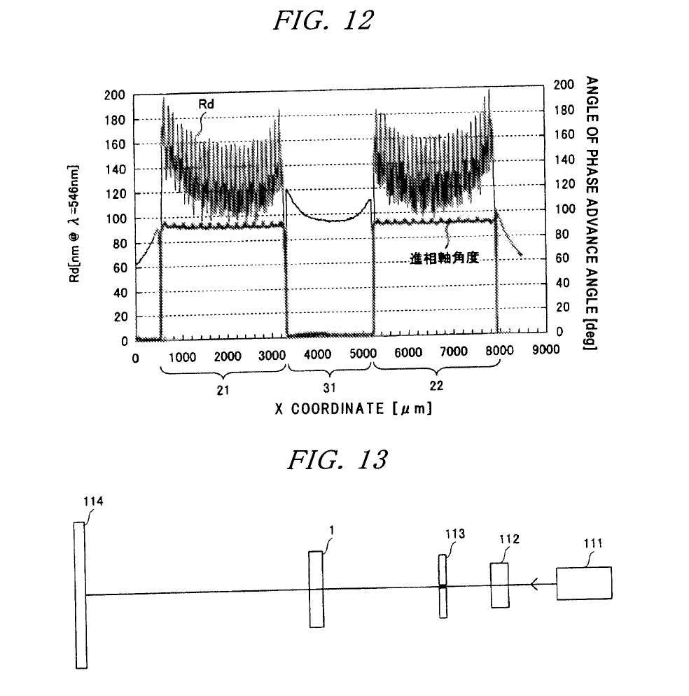

As shown in FIG. 13, light originating from a laser light source 111 is radiated on the third region 31 of the wave plate 1 of the embodiment by way of a light polarizer 112 and a pinhole 113, and a beam spot thrown on a screen 114 is observed.

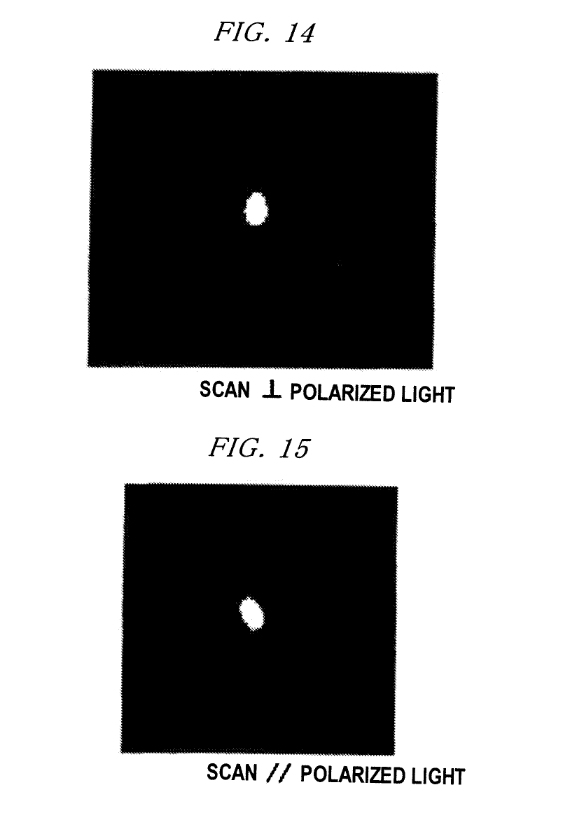

FIG. 14 shows a beam spot thrown on the screen 114 when a scan direction of the laser beam (a direction in which the scan line extends) achieved when the first region 21 and the second region 22 of the wave plate 1 of the embodiment are fabricated is placed so as to become substantially perpendicular to a direction of polarization of the light polarizer 112.

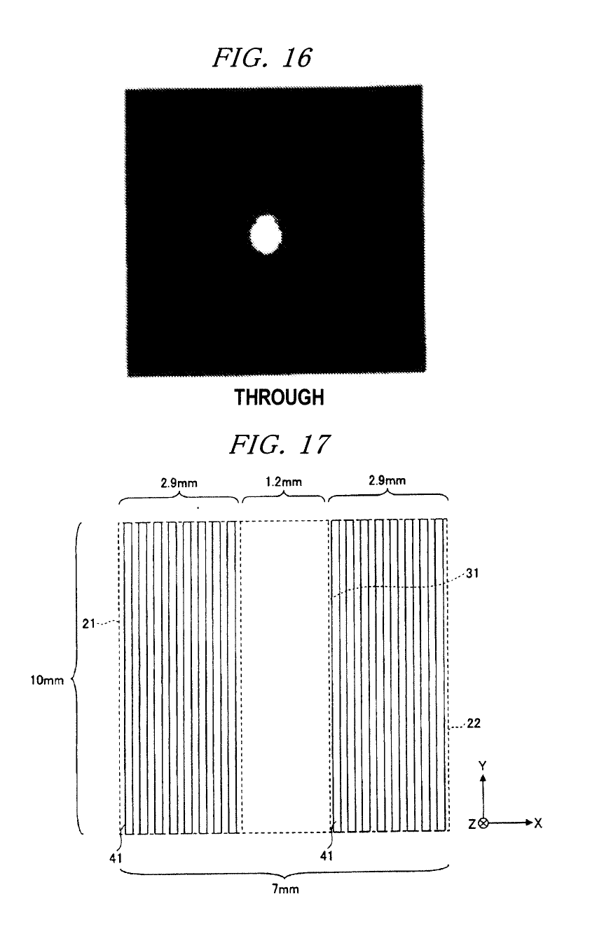

FIG. 15 shows a beam spot thrown on the screen 114 when the scan direction of the laser beam (the direction in which the scan line extends) achieved when the first region 21 and the second region 22 of the wave plate of the embodiment are fabricated is placed so as to become parallel to the direction of polarization of the light polarizer 112.

FIG. 16 shows, in the wave plate 1 of the embodiment, a beam spot that is thrown on the screen 114 in a state where the light polarizer 112 is not placed. It is understood that diffracted light is not observed in any cases and that superior beam spots are obtained. The wave plate of the embodiment is understood to be a wave plate that does not cause diffracted light and exhibits a superior optical characteristic.

### Second Embodiment

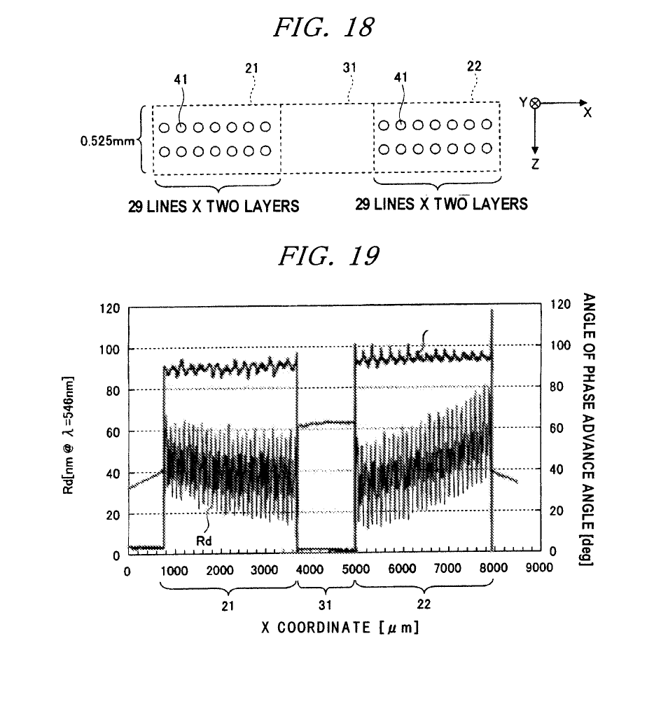

A wave plate of an implementation configuration that is to serve as a second embodiment is now described. The wave plate of the embodiment uses B270 produced by SCHOTT GLAS as the glass substrate 10 that has a size of 76 mm×26 mm and a thickness of 0.525 mm. As shown in FIGS. 17 and 18, the first region 21 and the second region 22 are fabricated by performing a scan with irradiation of the laser beam by the same technique as that employed in the first embodiment.

The first region 21 and the second region 22 are each fabricated in a region spaced, by 2.9 mm, away from either side of an aperture of the metal mask, and the third region 31 is fabricated between the first region 21 and the second region 22 so as to have a width of 1.2 mm.

A metal mask with an aperture measuring 7 mm×10 mm is placed on the glass substrate 10 at the time of irradiation of the laser beam. Subsequently, a scan is iterated over the first region 21 and the second region 22 with irradiation of the laser beam in the same way as in the first embodiment, a total of 58 scan lines are created in the first region 21 and the second region 22; namely, the scan line 41 is created in the number of 29 along the X-axis direction, and two layers of the scan lines 41 are created in the Z-axis direction.

The laser beam used for irradiation has a wavelength of 355 nm and power of 3.2 W, and a scan rate of the laser beam used for irradiation is 20 mm/sec. A pitch between the scan lines 41 of the radiated laser beam is 100 μm in both the X-axis direction and the Z-axis direction. FIG. 17 is a top view of the wave plate of the embodiment, and FIG. 18 is a cross sectional view of the same.

FIG. 19 shows a relationship among positions (X-coordinate positions) on the wave plate of the embodiment in the X-axis direction, retardation Rd caused by light having a wavelength of 546 nm, and angles of the phase advance axis. In the embodiment, the first region 21 of the wave plate is placed with X coordinates that range from 800 μm to 3700 μm; the second region 22 of the wave plate is placed with X coordinates that range from 4900 μm to 7800 μm; and the third region 31 of the wave plate is placed with X coordinates that range from 3700 μm to 4900 μm.

As shown in FIG. 19, when the X-coordinate position of the third region 31 is around 4500 μm, the retardation Rd assumes a value of about 60 nm. However, the number of scan lines 41 in the first region 21 and the second region 22 are increased to 98, whereby the value of the retardation Rd can be increased to a value of about 100 nm in the same way as in the case of the wave plate of the first embodiment. In this case, the wave plate of the embodiment acts as a quarter-wave plate with respect to blue light having a wavelength of about 400 nm.

An angle of the phase advance axis is about 90 degrees in the first region 21 and the second region 22, whilst an angle of the phase advance axis in the third region 31 is about 0 degree. Specifically, it is understood that the third region 31 exhibits uniaxial birefringence and that the first region 21 and the second region 22 exhibit uniaxial birefringence. Further, the phase advance axes of the first and second regions 21 and 22 are understood to be substantially parallel to each other, and the phase advance axis of the third region 31 is understood to be substantially orthogonal to the phase advance axis of the first region 21.

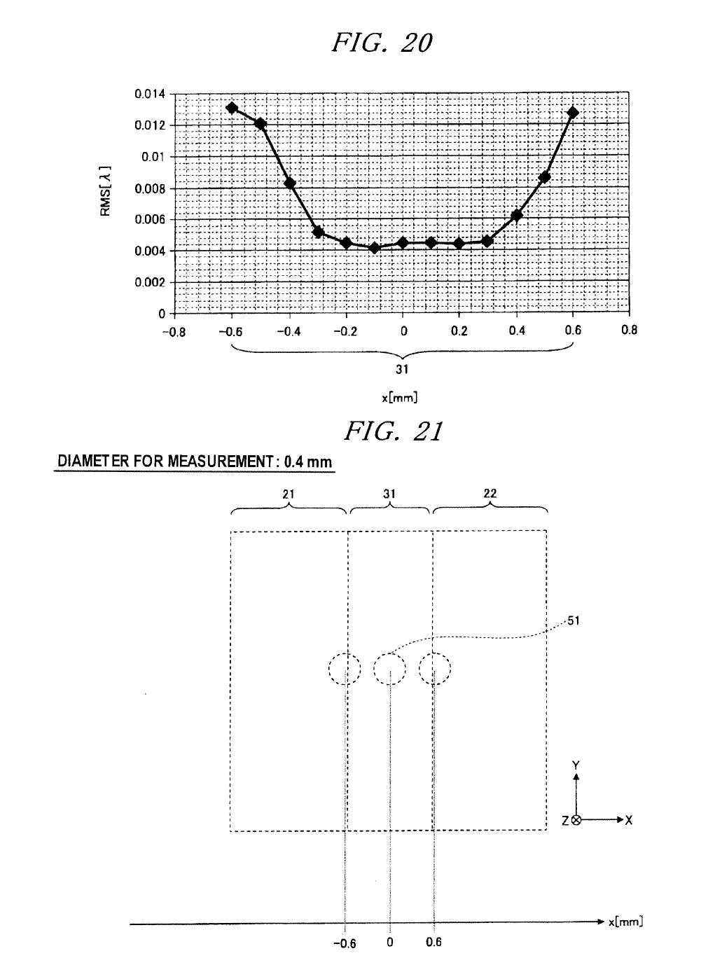

The wavefront aberration of the wave plate of the embodiment is now described. A phase shift interferometer is used as a measurement device, and a wavefront aberration is measured while a scan is made in the X-axis direction by use of a beam spot having a diameter of 0.4 mm. FIG. 20 shows data pertinent to a wavefront aberration measured, as shown in FIG. 21, by use of a beam spot 51 that has a wavelength of 400 nm and a diameter of 0.4 mm while a scan is made in the X-axis direction. The wavefront aberration observed in the third region 31 assumes values ranging from −0.4 mm to 0.4 mm along the X axis shown in FIG. 20. The RMS (root mean square) of the values shows a low value of 0.01λ or less. In particular, the RMS shows an extremely low value of 0.006λ or less within the range from −0.3 mm to 0.3 mm in the X-axis direction, where symbol λ denotes a measurement wavelength (400 nm). It is clear from the results that a low wavefront aberration exists within the third region 31 without regard to a measurement location.

In a common wave plate, the wavefront aberration causes fluctuations in a wavefront of transmitting light, which gives rise to stray light or noise in an optical signal. For these reasons, a low wavefront aberration is desirable. In the embodiment, it is ascertained that the wave plate of the invention yields a superior characteristic in connection with the wavefront aberration at any locations in the third region 31.

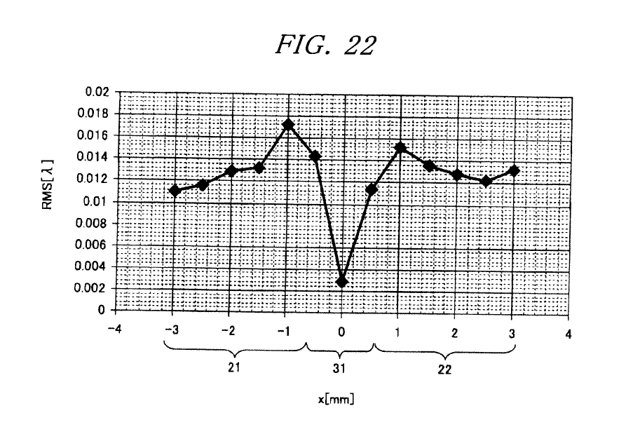

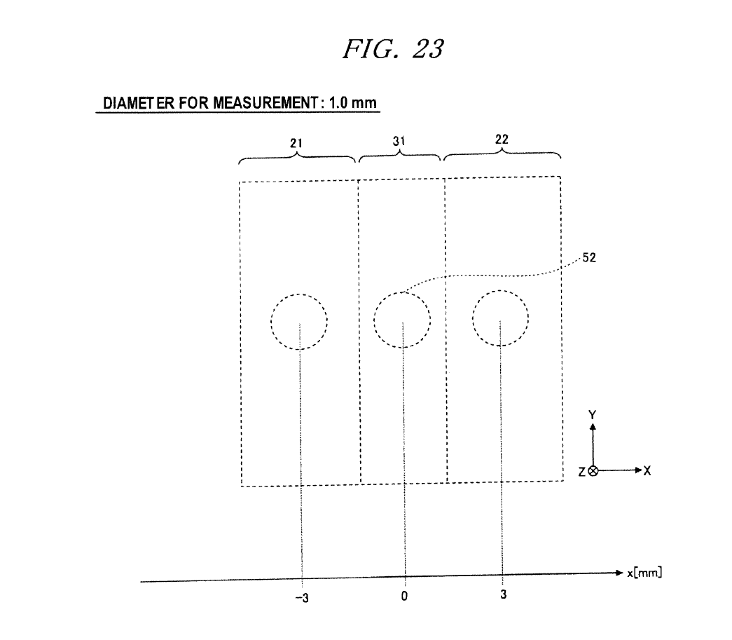

Likewise, FIG. 22 shows data pertinent to the wavefront aberration that is measured while a scan is made in the X-axis direction with use of a beam spot 52 having a diameter of 1.0 mm, and FIG. 23 shows a conceptual rendering of the wave plate. The wavefront aberration observed in the third region 31 assumes a value of 0 mm along the X axis in FIG. 22, and an RMS (root mean square) of the wavefront aberration shows a low value of 0.006λ or less.

It is generally desirable that a wide effective area should be present as an area by way of which light is incident on a wave plate. In the embodiment, it is ascertained that a superior characteristic pertinent to the wavefront aberration is yielded in a range of 1.0 mm or more within the third region 31 of the wave plate of the invention.

On the contrary, as shown in FIG. 22, there is a case where the wavefront aberration assumes a value of 0.01λ or more in the first region 21 and the second region 22. The value of the wavefront aberration is greater than the value of the wavefront aberration observed in the third region 31.

The technique described in connection with Patent Document 2 provides a proposal of use of a uniaxial birefringent region which is acquired by repeating a laser beam scan a number of times as a wave plate, like the first region 21 and the second region 22. As shown in FIG. 19, the first region 21 and the second region 22 of the embodiment exhibit uniaxial birefringence and act as wave plates. Accordingly, even when the technique described in connection with Patent Document 2 is used, the first region and the second region can be used as wave plates; however, there is a high probability that the wave plates may exhibit a high wavefront aberration. For this reason, the wave plates of the embodiment are superior to the wave plate described in connection with Patent Document 2 in terms of a low wavefront aberration.

### Third Embodiment

A wave plate of an implementation configuration that is to serve as a third embodiment is now described. The wave plate of the embodiment uses a slide glass S1112 produced by Matsunami Glass Ind. Ltd. as the glass substrate 10 that has a size of 76 mm×26 mm and a thickness of 1.0 mm.

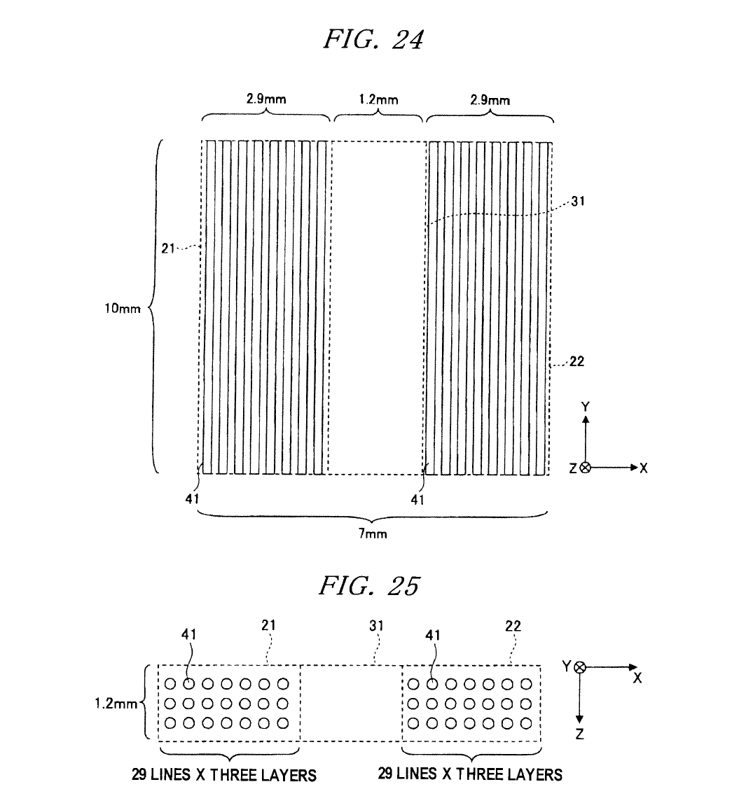

As shown in FIGS. 24 and 25, the first region 21 and the second region 22 are fabricated by performing a scan with irradiation of the laser beam by the same technique as that used in the first embodiment.

On this occasion, a metal mask with an aperture measuring 7 mm×10 mm is placed on the glass substrate 10. To be specific, a scan is iterated with irradiation of the laser beam, whereby a total of 87 scan lines are created in the first region 21 and the second region 22; namely, the scan line 41 is created in the number of 29 along the X-axis direction, and three layers of the scan lines 41 are created in the Z-axis direction.

The first region 21 and the second region 22 are each fabricated in a region spaced, by 2.9 mm, away from either side of an aperture of the metal mask, and the third region 31 is fabricated between the first region 21 and the second region 22 so as to have a width of 1.2 mm.

The laser beam used for irradiation has a wavelength of 355 nm and power of 3.2 W, and a scan rate of the laser beam used for irradiation is 20 mm/sec. A pitch between the scan lines 41 of the radiated laser beam is 100 μm. FIG. 24 is a top view of the wave plate of the embodiment, and FIG. 25 is a cross sectional view of the same.

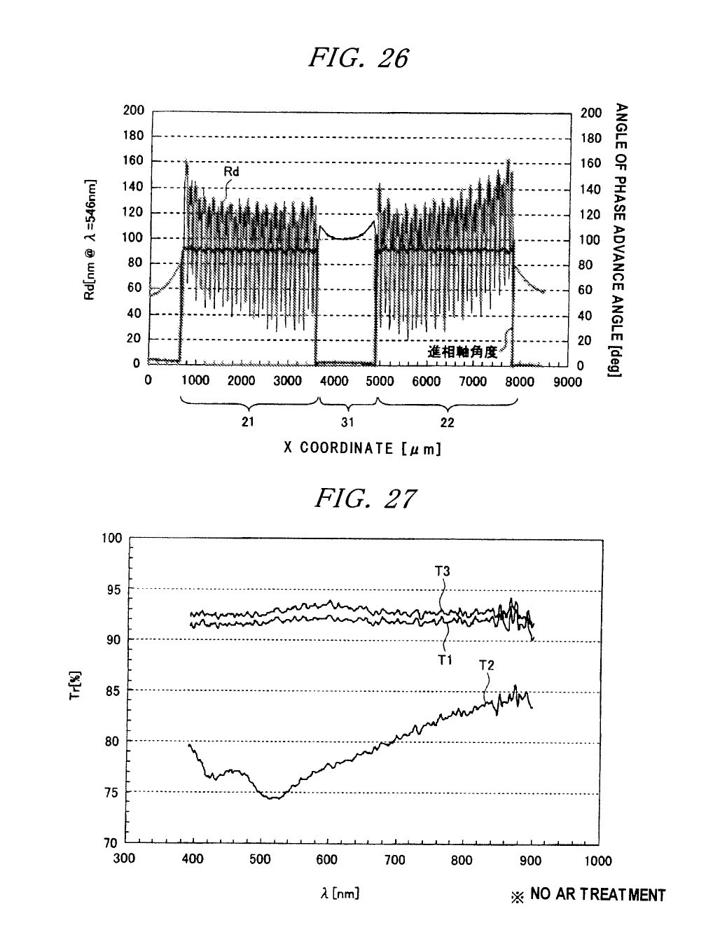

FIG. 26 shows a relationship among positions (X-coordinate positions) on the wave plate of the embodiment in the X-axis direction, retardation Rd, and angles of the phase advance axis caused by the light having a wavelength of 546 nm.

In the embodiment, the first region 21 of the wave plate is placed with X coordinates that range from 700 μm to 3600 μm; the second region 22 of the wave plate is placed with X coordinates that range from 4800 μm to 7700 μm; and the third region 31 of the wave plate is placed with X coordinates that range from 3600 μm to 4800 μm.

As shown in FIG. 26, when the X-coordinate position of the third region 31 is around 4000 μm, the retardation Rd assumes a value of about 100 nm. The wave plate of the embodiment acts as a quarter-wave plate with respect to blue light having a wavelength of about 400 nm.

Variations in retardation Rd observed in the third region 31 are small, and occurrence of diffracted light and the wavefront aberration is few. Further, the angle of the phase advance axis is about 90 degrees in both the first region 21 and the second region 22, whereas the angle of the phase advance axis is about 0 degree in the third region 31.

Explanations are next given to transmittance of the wave plate of the embodiment. FIG. 27 shows measurements of a relationship between a wavelength and transmittance acquired in the wave plate of the embodiment. In FIG. 27, symbol T1 denotes transmittance of a region (i.e., a region covered with the mask) other than the first region 21, the second region 22, and the third region 31; T2 denotes transmittance of the first region 21 and the second region 22; and T3 denotes transmittance of the third region 31.

As shown in FIG. 27, the transmittance T2 of the first region 21 and the second region 22 irradiated with the laser beam, which is an equivalent of a comparative example, is lower than the transmittance T1 of the area other than the first region 21, the second region 22, and the third region 31 by 10% or more over an entire visible range. Meanwhile, the transmittance 13 of the third region 31 is slightly higher than the transmittance T1 of the area other than the first region 21, the second region 22, and the third region 31.

The first region 21, the second region 22, and the third region 31 have substantially the same thickness, and no thickness difference exists among them. In relation to measurement conditions, measurement is performed with a spectroscopic analyzer by use of an optical beam whose beam spot to be used for measurement has a diameter of 0.5 mm.

The wave plate of the embodiment can cause retardation without a decrease in transmittance as above. Accordingly, the wave plate of the embodiment is a wave plate with a small loss of light quantity.

### Fourth Embodiment

A wave plate of an implementation configuration that is to serve as a fourth embodiment is now described. The embodiment is an example in which a magnitude of retardation that occurs in the third region 31 is controlled by regulating a volume of the uniaxial birefringent region included in the first region 21 and the second region 22.

The wave plate of the embodiment uses a slide glass S1112 produced by Matsunami Glass Ind. Ltd. as the glass substrate 10 that has a size of 76 mm×26 mm and a thickness of 1.0 mm.

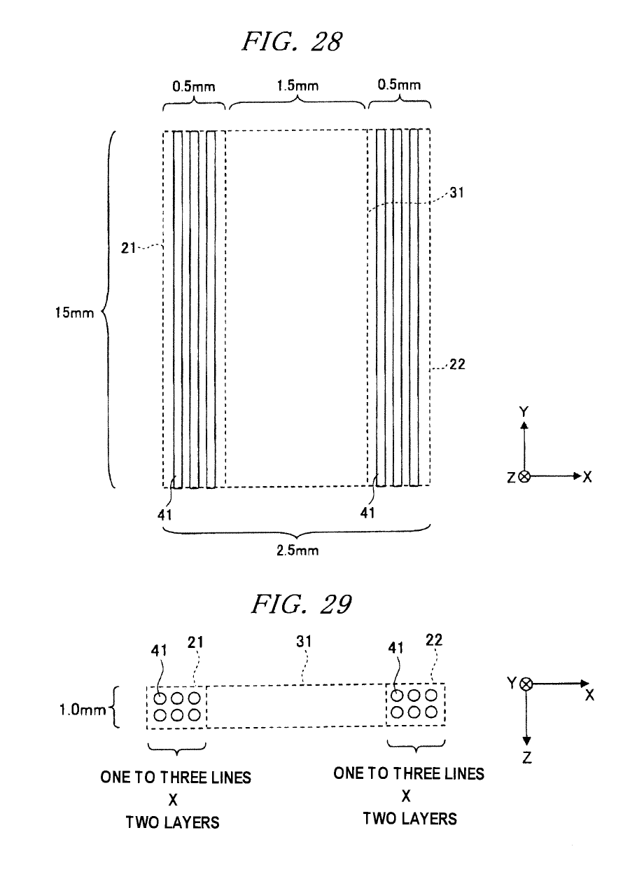

As shown in FIGS. 28 and 29, the first region 21 and the second region 22 are fabricated by performing a scan with irradiation of the laser beam by the same technique as that used in the first embodiment. On this occasion, a metal mask with an aperture measuring 15 mm×10 mm is placed on the glass substrate 10 in the same manner as in the first embodiment.

The volume of the uniaxial birefringent region is controlled by the number of laser scan lines 41. Three samples are fabricated by repetition of a scan with irradiation of the laser beam in the first region 21 and the second region 22; namely, a sample with one scan line 41 in the X-axis direction and one layer in the Z-axis direction, another sample with two scan lines 41 in the X-axis direction and one layer in the Z-axis direction, and still another sample with three scan lines 41 in the X-axis direction and one layer in the Z-axis direction. Processing is conducted such that, when two scan lines are included in each of the first region 21 and the second region 22, a pitch between adjacent scan lines is 0.5 mm and that, when three scan lines are included in each of the first region 21 and the second region 22, a pitch among adjacent scan lines is 0.25 mm.

At this time, the width of the third region 31 to be fabricated; namely, a spacing between the first region 21 and the second region 22, is set to 1.5 mm. Processing is performed on condition that a laser beam for irradiation has a wavelength of 355 nm and power of 3.2 W and that a scan rate of the laser beam for irradiation is 20 mm/sec. FIG. 28 is a top view of the wave plate of the embodiment, and FIG. 29 is a cross sectional view of the same.

By means of processing mentioned above, the first region 21 and the second region 22 each include a uniaxial birefringent region where phase advance axes are substantially parallel to each other, in the same manner as in the first embodiment, and uniaxial birefringence whose phase advance axes are substantially orthogonal to the phase advance axes of uniaxial birefringence included in the first region 21 is induced in the third region 31.

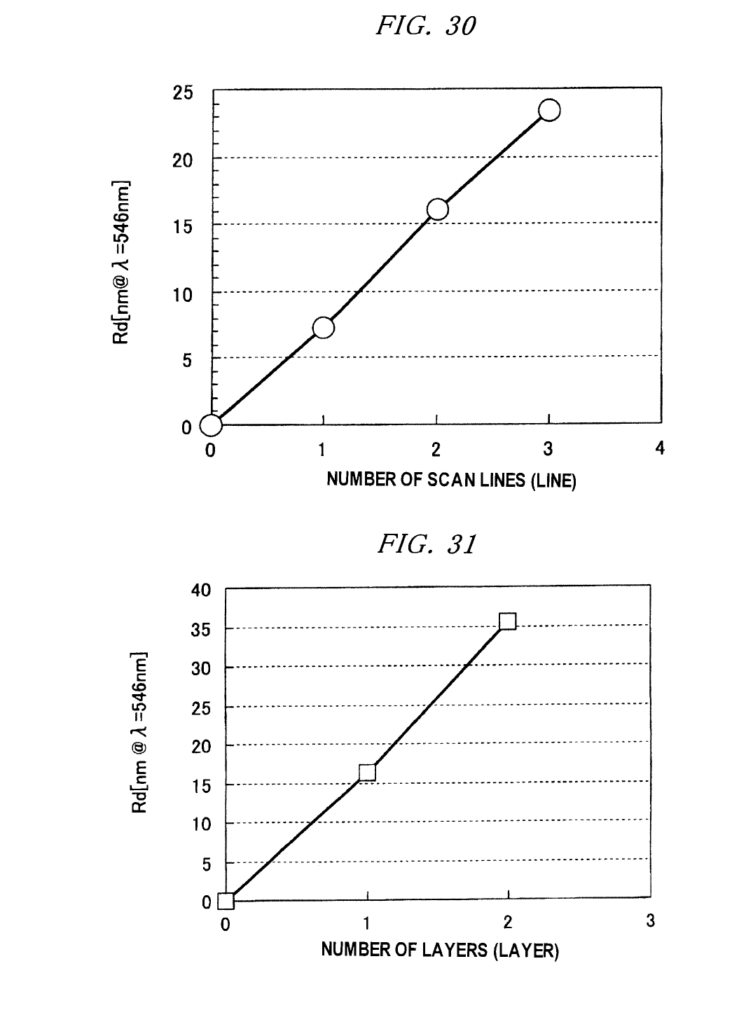

FIG. 30 shows a relationship between the number of lines formed by a scan (the number of scan lines) while the first region 21 and the second region 22 are irradiated with the laser beam and the retardation Rd that occurs in the third region 31 at a wavelength of 546 nm. As illustrated, the laser beam lines included in the first region 21 and the laser beam lines included in the second region 22 are both increased in number while aligned along the X-axis direction, whereby the volume of the uniaxial birefringent region can be increased, and the value of the retardation Rd induced in the third region 31 can be increased. The number of scan lines shown in FIG. 30 represents the number of laser beam scan lines in the first region 21 and the second region 22.

Likewise, two samples are fabricated in the first region 21 and the second region 22 by iteration of a scan with irradiation of the laser beam; namely, one sample with two scan lines 41 in the X-axis direction and one layer in the Z-axis direction and another sample with two scan lines 41 in the X-axis direction and two layers in the Z-axis direction.

In each of the first region 21 and the second region 22, a pitch between adjacent scan lines in the X-axis direction is 0.5 mm, and a pitch between adjacent scan lines in the Z-axis direction is 0.1 mm. On this occasion, the width of the third region 31 to be fabricated; namely, a spacing between the first region 21 and the second region 22, is set to 1.5 mm. FIG. 28 is a top view of the wave plate of the embodiment, and FIG. 29 is a cross sectional view of the same.

By means of processing mentioned above, the first region 21 and the second region 22 each include a uniaxial birefringent region where phase advance axes are substantially parallel to each other, in the same manner as in the first embodiment, and uniaxial birefringence whose phase advance axes are substantially orthogonal to the phase advance axes of uniaxial birefringence included in the first region 21 is induced in the third region 31.

FIG. 31 shows a relationship between the number of layers formed by a scan (the number of scan lines) in the thickness-wise direction (the Z-axis direction) of the glass substrate 10 while the first region 21 and the second region 22 are irradiated with the laser beam and the retardation Rd that occurs in the third region 31 at a wavelength of 546 nm. As in the case with the X-axis direction, the number of layers (scan lines) even in the Z-axis direction is increased, whereby the volume of the uniaxial birefringent region is increased, so that the value of retardation Rd can be increased.

### Fifth Embodiment

A wave plate is fabricated through the following steps by use of an apparatus, such as that shown in FIG. 37.

First, a glass substrate (borosilicate glass) having a thickness of 1 mm is prepared.

A series of laser beams are radiated on the glass substrate from above in a stationary manner by way of a lens (NA=0.6).

AVIA-355-28 with a wavelength of 355 nm produced by Coherent Co., Ltd. is used as a laser light source. A laser beam output is set to 24 W.

The laser beam is divided into 18 branch laser beams by means of a diffraction optical element. Laser spots of the respective branch laser beams assume each a circular shape with a diameter of 1 μm.

Nine branch laser beams (a first laser beam group) of the branch laser beams are radiated in a stationary manner on a first region (a depth of 0.5 mm from the surface) of the glass substrate, and the remaining nine laser beams (a second laser beam group) are radiated in a stationary manner on a second region (a depth of 0.5 mm from the surface). The first region and the second region are arrayed along a first direction. In the first laser beam group, the laser spots of the respective laser beams are linearly arrayed along a second direction (a direction perpendicular to the first direction). Also, in the second laser beam group, the laser spots of the respective laser beams are linearly arrayed in the second direction (the direction perpendicular to the first direction).

In the first laser beam group, a ratio between laser intensity of the laser spots at both ends of the line and laser intensity of the remaining seven laser spots is set to 10:6. Thus, the laser spots at both ends of the line are made higher than the laser intensity of the other laser spots. Likewise, in the second laser beam group, a ratio between laser intensity of the laser spots at both ends of the line and laser intensity of the remaining seven laser spots is set to 10:6.

In the first and second laser beam groups, a pitch between the laser spots is set to 150 μm. A spacing between the first region and the second region (i.e., a distance between the centers of the laser spots of both regions determined by measurement) is set to 1 mm.

Irradiating the first region with the first laser beam group in a stationary manner and irradiating the second region with the second laser beam group in a stationary manner are simultaneously performed. Moreover, a time to irradiate each of the regions with each of the laser beam groups is set to four seconds.

Birefringent regions are thereby fabricated in the glass substrate.

FIG. 38 shows a result of measurement of a retardation distribution that appears in the thus-fabricated birefringent regions along the first direction (a direction perpendicular to the direction in which laser spots of both laser beam groups are arrayed).

A birefringent imaging system Abrio produced by Cri Co., Ltd. is used for measuring the retardation distribution. Under the technique, there is employed a configuration in which a light source and a circular polarization filter are placed in front of a sample and in which an elliptical polarization analyzer and a CCD camera are placed behind the sample. In the configuration, a state of a liquid crystal optical element is changed in the elliptical polarization analyzer, and a plurality of images captured through the elliptical polarization analyzer are acquired by the CCD camera. These images are subjected to comparative calculation, whereby resultant retardation can be quantified.

As is obvious from FIG. 38, what is observed in the birefringent regions includes, in sequence from left, the first small peak Q1 (at a position of about 500 μm) of a retardation value, the first peak P1 (a position of about 750 μm) of the retardation value, the first flat part B1 (at a position ranging from about 1000 μm to 1500 μm) of the retardation value, the second peak P2 (at a position of about 1750 μm) of the retardation value, and the second small peak Q2 (at a position of about 2000 μm) of the retardation value.

A location where the first peak P1 of the retardation value occurred corresponds to a region irradiated in stationary manner with the first laser beam group; namely, the first region. Further, a location where the second peak P2 of the retardation value occurred corresponds to the region irradiated in a stationary manner with the second laser beam group; namely, the second region.

It is ascertained from these results that a third region having the first flat part B1 of the retardation value is fabricated between the first region and the second region.

Subsequently, the glass substrate is diced at two locations so as to traverse the birefringent region. The glass substrate is diced at this time so as to pass through the position of the small peak Q1 and the position of the small peak Q2 along a direction parallel to the second direction (the direction in which the laser spots of both laser beam groups are arrayed).

The glass substrate is then further diced at two locations so as to pass by the outside of the spots at both ends of the respective laser beam groups along a direction perpendicular to the second direction.

Fractures or cracking do not arise in the glass substrate in the middle of cutting or after cutting operation.

### Sixth Embodiment

A wave plate is fabricated by the same technique as that described in connection with the fifth embodiment.

In this respect, an output of the laser beam originating from the laser light source is set to 20 W in the sixth embodiment. The other conditions are analogous to those described in connection with the fifth embodiment.

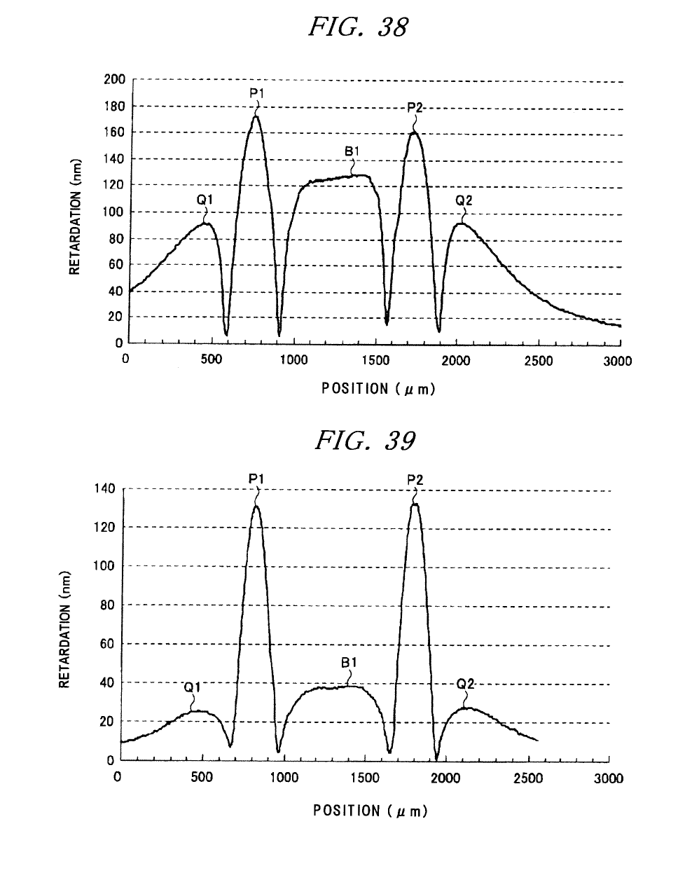

FIG. 39 shows a result of measurement of retardation distributions that appear in the thus-fabricated birefringent regions along the first direction (a direction perpendicular to the direction in which laser spots of both laser beam groups are arrayed).

As is obvious from FIG. 39, what is observed in the birefringent regions include, in sequence from left, the first small peak Q1 (at a position of about 500 μm) of a retardation value, the first peak P1 (a position of about 800 μm) of the retardation value, the first flat part B1 (at the position ranging from about 1000 μm to 1600 μm) of the retardation value, the second peak P2 (at a position of about 1800 μm) of the retardation value, and the second small peak Q2 (at a position of about 2100 μm) of the retardation value.

A location where the first peak P1 of the retardation value occurred corresponds to a region irradiated in stationary manner with the first laser beam group; namely, the first region. Further, a location where the second peak P2 of the retardation value occurred corresponds to the region irradiated in a stationary manner with the second laser beam group; namely, the second region.

It is ascertained from these results that a third region having the first flat part B1 of the retardation value is fabricated between the first region and the second region.

As is obvious from the form of the first flat part B1, the retardation distribution appearing in the third region falls within a range of ±5%. It is thus seen from the sixth embodiment that a comparatively uniform retardation distribution appears in the center of the birefringent region.

Subsequently, the glass substrate is diced at two locations so as to traverse the birefringent region. The glass substrate is diced at this time so as to pass through the position of the small peak Q1 and the position of the small peak Q2 along a direction parallel to the second direction (the direction in which the laser spots of both laser beam groups are arrayed).

The glass substrate is then further diced at two locations so as to pass by the outside of the spots at both ends of the respective laser beam groups along the direction perpendicular to the second direction.

Fractures or cracking do not arise in the glass substrate in the middle of cutting or after cutting operation.

### Seventh Embodiment

A wave plate is fabricated by the same technique as that described in connection with the sixth embodiment.

In this respect, in the seventh embodiment, an irradiation time of each of the laser beams is changed; three seconds (Case A); five seconds (Case B); and 6.6 seconds (Case C), to thus fabricate birefringent regions. The other conditions are analogous to those described in connection with the sixth embodiment.

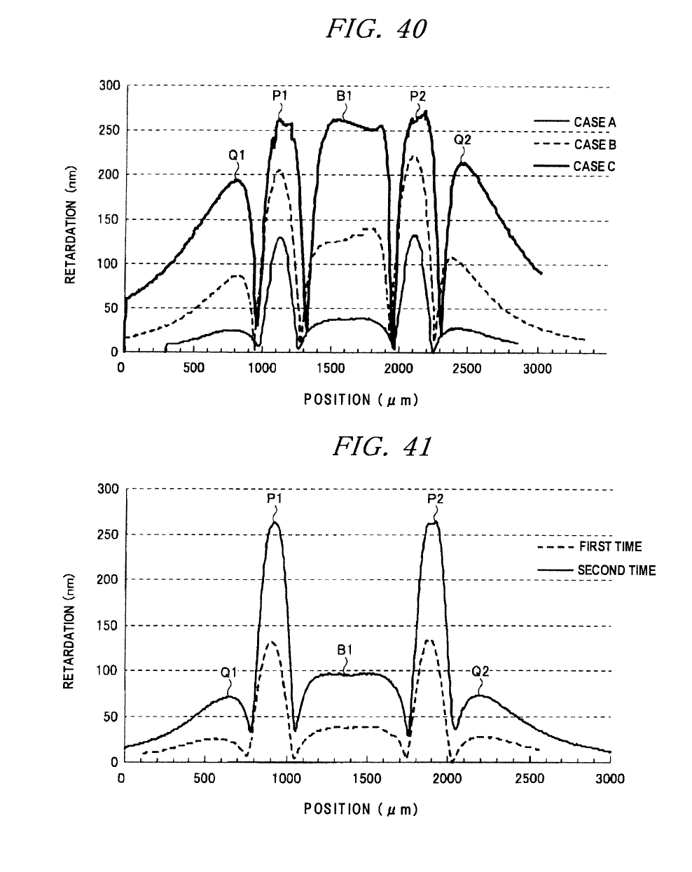

FIG. 40 collectively shows results of measurement of retardation distributions that appear in the thus-fabricated birefringent regions along the first direction (a direction perpendicular to the direction in which laser spots of both laser beam groups are arrayed) at the respective irradiation times.

As is obvious from FIG. 40, what is observed in the birefringent regions in all the cases includes, in sequence from left, the first small peak Q1 (at a position of about 800 μm) of the retardation value, the first peak P1 (a position of about 1100 μm) of the retardation value, the first flat part B1 (at the position ranging from about 1400 μm to 1900 μm) of the retardation value, the second peak P2 (at a position of about 2100 μm) of the retardation value, and the second small peak Q2 (at a position of about 2400 μm) of the retardation value.

A location where the first peak P1 of the retardation value occurred corresponds to a region irradiated in stationary manner with the first laser beam group; namely, the first region. Further, a location where the second peak P2 of the retardation value occurred corresponds to the region irradiated in a stationary manner with the second laser beam group; namely, the second region.

It is ascertained from these results that a third region having the first flat part B1 of the retardation value is fabricated between the first region and the second region.

Comparison among Cases A to C shows that the peak and the flat part of the retardation value increase with an increase in irradiation time, to thus make the form of the retardation distribution more noticeable as shown in FIG. 32 (for instance, the retardation value of the first flat part B1 in Case C shows an increase that is six times as large as the retardation value of Case A). It is, however, understood that, even when the irradiation time is changed, a significant change does not arise in the position of the peak or the flat part of the retardation value and that a birefringent region exhibiting a retardation distribution of a similar form is obtained.

FIG. 40 shows a result in support of superior reproducibility of the method for producing a wave plate of the invention. To be specific, any substantial change does not arise, on the three processing conditions, in the region where the peak or flat part of the retardation value occurs and that corresponds to the locations on the glass substrate. It is ascertained from the fact that the invention enables fabrication of a birefringent region showing a state of similar retardation with superior reproducibility by fixing process conditions.

### Eighth Embodiment

A wave plate is fabricated by the same technique as that described in connection with the sixth embodiment.

In an eighth embodiment, however, birefringent region formation processing described in connection with the sixth embodiment is iterated twice. Specifically, second birefringent region formation processing is performed after first birefringent region formation processing while the depth of the glass substrate to be exposed to the laser beam group is changed. The first birefringent region formation processing is performed at a depth of 0.6 mm from laser-entrance-side surface of the glass substrate, and the second birefringent region formation processing is performed at a depth of 0.4 mm from the surface of the glass substrate. In this regard, the region to be exposed to the first laser beam group and the region to be exposed to the second laser beam group during the first and second birefringent region formation processing are made tantamount to each other when viewed from the thicknesswise direction of the glass substrate. The other conditions are analogous to those described in connection with the sixth embodiment.

FIG. 41 collectively shows results of measurement of retardation distributions that appear in the birefringent regions along the first direction (a direction perpendicular to the direction in which laser spots of both laser beam groups are arrayed) after the first birefringent region formation processing and the second birefringent region formation processing.

As is obvious from FIG. 41, what is observed in the birefringent regions after all the birefringent region formation processing operations includes, in sequence from left, the first small peak Q1 (at a position of about 650 μm) of the retardation value, the first peak P1 (a position of about 900 μm) of the retardation value, the first flat part B1 (at the position ranging from about 1100 μm to 1700 μm) of the retardation value, the second peak P2 (at a position of about 1900 μm) of the retardation value, and the second small peak Q2 (at a position of about 2200 μm) of the retardation value.

A location where the first peak P1 of the retardation value occurred corresponds to a region irradiated in stationary manner with the first laser beam group; namely, the first region. Further, a location where the second peak P2 of the retardation value occurred corresponds to the region irradiated in a stationary manner with the second laser beam group; namely, the second region.

It is ascertained from these results that the third region having the first flat part B1 of the retardation value is fabricated between the first region and the second region.

Comparison between the two measurement results shows that the peaks and the flat parts of the retardation value increase as a result of iteration of birefringent region formation processing while the depth is changed, to thus make the form of the retardation distribution, such as that shown in FIG. 32, more noticeable. (For instance, the retardation value of the first flat part B1 is increased about twice after the second birefringent region formation processing when compared with the retardation value acquired after the first birefringent region formation processing). It is, however, understood that, even when birefringent region formation processing is iterated, a significant change does not arise in the position of the peak or the flat part of the retardation distribution and that a birefringent region exhibiting a retardation distribution of a similar form is obtained.

FIG. 41 shows a result in support of superior reproducibility of the method for producing a wave plate of the invention. To be specific, twice processing operations do not induce any substantial changes in the region where the peak or flat part of the retardation value occurs and that corresponds to the locations on the glass substrate. It is ascertained from the fact that the invention enables fabrication of a birefringent region showing a state of similar retardation with superior reproducibility by fixing process conditions.

As above, it is ascertained that, under the method of the invention, a wave plate with an intended birefringent region can be produced without performing a laser beam scan over the glass substrate. Accordingly, the invention can provide a method for producing a wave plate that enables significant inhibition of occurrence of variations in a state of a birefringent region, which would otherwise occur in producing steps, and provision of a method for producing a wave plate.

The modes for implementing the invention have been described thus far, but the above descriptions shall not restrict details of the invention.

Although the patent application has been described in detail and by reference to the specific implementation modes, it is manifest to those who are skilled in the art that the invention be susceptible to various alterations and modifications without departing the spirit and scope of the invention.

The patent application is based on Japanese Patent Application (JP-2011-01240) filed on Jan. 20, 2011, and Japanese Patent Application (JP-2011-158406) filed on Jul. 19, 2011, the subject matters of which are incorporated herein by reference.

### DESCRIPTION OF REFERENCE NUMERALS

1 WAVE PLATE
10 GLASS SUBSTRATE
21 FIRST REGION
22 SECOND REGION
31 THIRD REGION
41 SCAN LINE
100 LASER BEAM
101 LIGHT SOURCE
102 MIRROR
103 MIRROR
104 LENS
105 XY STAGE
106 COMPUTER
110 METAL MASK
111 LASER LIGHT SOURCE
112 LIGHT POLARIZE
113 PINHOLE
114 SCREEN
115 APERTURE
116 FIRST LASER SCAN REGION
117 SECOND LASER SCAN REGION
120 FIRST LASER BEAM GROUP
130 SECOND REGION
140 SECOND LASER BEAM GROUP
150 THIRD REGION
120A TO 120F LASER SPOT
140A TO 140F LASER SPOT
120G TO 120L LASER SPOT
140G TO 140L LASER SPOT
120X1, 120X2 LINE
120X1, 140X2 LINE
200 APPARATUS
220 LASER BEAM
230 LENS
250 DIFFRACTION OPTICAL ELEMENT
260A TO 260F BRANCH LASER BEAM
270A TO 270F LASER SPOT
280 FIRST REGION
290 SECOND REGION
310 FIRST REGION
P1 FIRST PEAK
P2 SECOND PEAK
B1 FLAT PART
Q1 FIRST SMALL PEAK
Q2 SECOND SMALL PEAK

1. A wave plate comprising:
a first region; a second region; and
a third region which are placed on a glass substrate, wherein:
the first region and the second region exhibit each uniaxial birefringence at least in their portions;
the third region exhibits uniaxial birefringence and is interposed between the first region and the second region;
phase advance axes of birefringence of the first region and the second region are substantially parallel to each other; and
a phase advance axis of birefringence of the third region is substantially orthogonal to the phase advance axes of birefringence of the first and second regions.

2. The wave plate according to claim 1, wherein:
the first region and the second region are created by irradiation of a laser beam; and
the third region is a region that is not exposed to the laser beam.

3. The wave plate according to claim 1, wherein
the first region and the second region are placed substantially parallel to each other.

4. The wave plate according to claim 1, wherein
a spacing between the first region and the second region is wider than a diameter of a beam spot that enters the wave plate.

5. The wave plate according to claim 1, wherein
retardation of the third region corresponds to a quarter or a half of a wavelength of the light that enters the wave plate.

6. A method for producing a wave plate including a first region, a second region, and a third region which are placed on a glass substrate, and the third region is interposed between the first region and the second region, the method comprising:
a step of fabricating the first region on the glass substrate by performing a scan with irradiation of a laser beam in one direction; and
a step of fabricating the second region that is spaced apart from the first region by a predetermined distance, by performing a scan with irradiation of the laser beam substantially in parallel to the one direction.

7. The method for producing a wave plate according to claim 6, wherein
irradiation of the laser beam is performed a plurality of times substantially parallel to the one direction with respect to a thicknesswise or planar direction of the glass substrate.

8. The method for producing a wave plate according to claim 6, wherein
processing pertaining to the step of fabricating the first region and processing pertaining to the step of fabricating the second region are simultaneously performed.

9. A method for producing on a glass substrate a wave plate with a birefringent region, comprising:
preparing a glass substrate; and
irradiating a first region on the glass substrate and a second region spaced apart from the first region with a laser beam in a stationary manner, wherein
a first peak of retardation value appears in the first region and a second peak of the retardation value appears in the second region with respect to a direction that traverses the first and second regions, and a flat part or peak of the retardation value is formed in a third region between the first and second regions.

10. The method for producing a wave plate according to claim 9, wherein:
the first region is fabricated by irradiation of one or a plurality of first laser beams; and
the second region is fabricated by irradiation of one or a plurality of second laser beams.

11. The method for producing a wave plate according to claim 10, wherein
at least one first laser beam and/or at least one second laser beam have a linear or elliptical laser spot.

12. The method for producing a wave plate according to claim 10, wherein
the first, third, and second regions are fabricated along a first direction;
laser spots of the plurality of first laser beams to be radiated on the first region are arrayed along a second direction substantially perpendicular to the first direction; and
laser spots of the plurality of second laser beams to be radiated on the second region are arrayed along the second direction.

13. The method for producing a wave plate according to claim 12, wherein:
the first, third, and second regions are fabricated along the first direction;
at least one linear or elliptical laser spot of the first laser beam is arrayed such that a major axis of the laser spot becomes parallel to the second direction that is substantially perpendicular to the first direction, and/or
at least one linear or elliptical laser spot of the second laser beam is arrayed such that a major axis of the laser spot becomes parallel to the second direction that is substantially perpendicular to the first direction.

14. The method for producing a wave plate according to claim 12, wherein:
the laser spots of the plurality of first laser beams make up a plurality of lines along the second direction; and
the laser spots of the plurality of second laser beams make up a plurality of lines along the second direction.

15. The method for producing a wave plate according to claim 12, wherein:
the laser spots of the plurality of first laser beams are each a linear or elliptical laser spot;
the laser spots of the plurality of second laser beams are each a linear or elliptical laser spot;
the linear or elliptical laser spots of the first laser beams are arrayed such that a major axis of each of the laser spots is arrayed in parallel to the second direction; and
the linear or elliptical laser spots of the second laser beams are arrayed such that a major axis of each of the laser spots is arrayed in parallel to the second direction.

16. The method for producing a wave plate according to claim 10, wherein:
the laser spots of the plurality of first laser beams have intensity such that both ends of the line of laser spots have higher intensity; and
the laser spots of the plurality of second laser beams have intensity such that both ends of the line of laser spots have higher intensity.

17. The method for producing a wave plate according to claim 9, wherein
when the first region on the glass substrate and the second region spaced apart from the first region are irradiated with a laser beam in the stationary manner, the laser beam is irradiated on the first region and the second region simultaneously.

18. The method for producing a wave plate according to claim 9, wherein
when the first region on the glass substrate and the second region spaced apart from the first region are irradiated with a laser beam in the stationary manner, the laser beam is irradiated on the second region after being radiated on the first region.

19. The method for producing a wave plate according to claim 6, wherein
a spacing between the first region and the second region is a maximum of 10 mm or less.

20. The method for producing a wave plate according to claim 9, wherein
a spacing between the first region and the second region is a maximum of 10 mm or less.

21. The method for producing a wave plate according to claim 9, wherein:
when the first region on the glass substrate and the second region spaced apart from the first region are irradiated with a laser beam in the stationary manner, the first region of the glass substrate and the second region spaced apart from the first region are irradiated with the laser beam at a first depth of the glass substrate, and at a second depth of the glass substrate, a fourth region of the glass substrate and a fifth region spaced apart from the fourth region with the laser beam in a stationary manner at a second depth of the glass substrate; and
the fourth region coincides with the first region when viewed in a thicknesswise direction of the glass substrate, and the fifth region coincides with the second region when viewed in the thicknesswise direction of the glass substrate.
